(19) United States
(12) Patent Application Publication
(10) Pub. No.: US 2024/0384425 A1
(43) Pub. Date: Nov. 21, 2024

(54) NANO-ENGINEERED CATALYST FOR IMPROVING THE FARADAIC EFFICIENCY OF ENERGY CONVERSION AND ELECTROLYSIS SYSTEMS

(71) Applicant: UCHICAGO ARGONNE LLC, Chicago, IL (US)

(72) Inventors: Ahmed A. Farghaly, Westmont, IL (US); Deborah J. Myers, Lisle, IL (US)

(73) Assignee: UCHICAGO ARGONNE LLC, Chicago, IL (US)

(21) Appl. No.: 18/653,725

(22) Filed: May 2, 2024

Related U.S. Application Data
(60) Provisional application No. 63/463,508, filed on May 2, 2023.

(51) Int. Cl. C25B 11/093; C25B 3/07; C25B 3/26; C25B 11/031; H01M 4/86; H01M 4/92; H01M 8/10; H01M 8/1011

(52) U.S. Cl. CPC C25B 11/093; C25B 3/07; C25B 3/26; C25B 11/031; H01M 4/8605; H01M 4/8673; H01M 4/926; H01M 8/1011; H01M 2008/1095

(57) ABSTRACT

A method of improving Faradaic efficiency in an electrochemical device includes providing a catalyst at an electrode of the electrochemical device. The catalyst includes a nanoparticle comprising a metal or metal alloy. The nanoparticle is selected to improve catalytic performance in the electrochemical device. The catalyst further includes an electron-conductive nano-zeolitic framework encasing the nanoparticle. The nano-zeolitic framework includes a hollow three-dimensional framework defining a catalyst surface, an internal cavity in which the nanoparticle is disposed, and a plurality of pores extending through the nano-zeolitic framework. The plurality of pores have a size and shape selected to block molecules corresponding to undesired reactions in the electrochemical device. The method further includes selectively promoting a desired reaction at the catalyst surface and selectively blocking the undesired reactions at the catalyst surface.

### CROSS-REFERENCE TO RELATED PATENT APPLICATION

This invention claims the benefit of and priority to U.S. Provisional Application No. 63/463, 508, filed May 2, 2023, the entire disclosure of which is incorporated by reference herein.

### STATEMENT OF GOVERNMENT INTEREST

This invention was made with government support under Contract No. DE-AC02-06CHI11357 between the United States Department of Energy and UChicago Argonne, LLC, operator of Argonne National Laboratory. The government has certain rights in the invention.

### TECHNICAL FIELD

The present disclosure relates generally to a method of synthesizing and composition of nanoengineered catalysts. More specifically, the present disclosure relates to a nanoengineered catalyst including a nanoparticle encased in an electron-conductive nano-sized hierarchically porous three-dimensional inorganic framework.

### BACKGROUND

A transition towards more sustainable energy sources has become imperative to reduce reliance on fossil fuels, ensure energy security, and mitigate climate change. Sustainable energy technologies offer solution to address these challenges by providing cleaner, renewable alternatives for energy. Electrochemical processes play a role in many sustainable energy technologies. Systems utilizing electrochemical processes may be powered by renewable energy sources and provide cleaner and more efficient energy conversion. One area of interest has been the conversion of widely available carbon dioxide (CO₂) in the atmosphere into fuels and chemicals through electrochemical reduction of CO₂. Another area of interest has been the use of low temperature fuel cells that generate electricity through an electrochemical reaction rather than combustion. Low temperature fuel cells run on a variety of fuels, including hydrogen or alcohols, and can provide cleaner, more efficient, reliable, and quieter sources of power. Three electrochemical systems involving energy conversion are discussed below. To implement these systems on a larger scale, improvements in efficiency and performance are needed.

Energy conversion/electrolysis systems use catalysts to enhance the efficiency and selectivity of the electrochemical reactions involved in the process. Catalysts may facilitate the electrochemical reactions (oxidation reactions, reduction reactions) occurring at electrodes, and increase reaction rates, thereby improving the performance of the system overall.

One metric for evaluating the performance, cost-effectiveness, and environmental sustainability of electrochemical processes is Faradaic Efficiency (FE). Faradaic efficiency is a parameter that measures the extent to which desired products are formed during an electrochemical reaction compared to undesired side reactions. Essentially, the FE of a given product is the selectivity of reducing CO₂ to that product (e.g., formation of the product). Devices using processes with high FE are more cost-effective (more efficient utilization of materials), and more energy efficient (consumes less energy). Therefore, improving FE is necessary to improve economic viability, and reducing environmental impact.

### CO₂ Electrolyzers

CO₂ electrolyzers enable the conversion of CO₂ into valuable products (e.g., formic acid (HCOOH), carbon monoxide (CO), methane (CH₄), ethylene (C₂H₄), etc.) through an electrochemical process. In a CO₂ electrolyzer, CO₂ molecules are reduced at the cathode and water molecules (H₂O) are typically oxidized at the anode, leading to the formation of these valuable products. Unintended reactions may also occur during the electrochemical CO2 reduction reaction (CO2RR). This can include the crossover of valuable CO2RR products such as formate. This occurs when formate ions produced at the cathode diffuse through the electrolyte and the membrane to the anode. At the anode, formate ions may undergo oxidation.

The diffusion of value-added chemical products (e.g., formate) from the cathode, where it is produced in the CO₂ reduction reaction (CO₂RR), to the anode may result in loss of product and/or fuel, as well as power limitations and FE losses. There is a need for a catalyst that facilitates the selective blocking of such reactions at the anode in CO₂ electrolyzers to significantly increase the FE of CO₂ electrolyzers and allow recovery of valuable products.

### Direct Methanol Fuel Cels (DMFCs)

DMFCs are electrochemical energy conversion devices where the chemical energy of liquid methanol is converted to electrical energy through electrochemical oxidation of the methanol and reduction of oxygen rather than chemical combustion. Methanol is an alternative fuel that is energy-dense and stable at all environmental conditions. In DMFCs, methanol crossover is a phenomenon by which methanol diffuses from the anode through the membrane to the cathode where it is oxidized by oxygen rather than through the electrochemical fuel cell reaction to produce electrical energy, significantly decreasing efficiency. This results in power limitations and FE losses. Further, the methanol crossover can decrease the electrochemical potential of the cathode in DMFCs, causing loss of cell efficiency. Depolarization occurs because the cathode catalyst is active for both the oxygen reduction reaction (ORR) and the methanol oxidation reaction (MOR), thus, the potential of the cathode is controlled by both reactions. Therefore, there is a need for a catalyst that facilitates the selective blocking of methanol crossover from the anode to the cathode to increase the power output of DFMCs, making the DMFC more viable for portable applications.

### Proton Exchange Membrane Fuel Cells (PEMFCs)

PEMFCs are another type of fuel cell used to convert the chemical energy of fuels, such as hydrogen, to electricity through an electrochemical reaction with oxygen from the air. Interactions between the perfluorosulfonic acid (PFSA) ionomer and the cathode catalyst surface in PEMFCs result in a loss in cell voltage, performance, and efficiency. Catalyst-ionomer reactions lead to the formation of a thin ionomer film coating the catalyst particles, significantly inhibiting ORR kinetics at the cathode, thereby poisoning the PEMFC cathode catalyst and significantly decreasing transport of oxygen to the catalyst surface, and loss of cell voltage, particularly at high current densities. Therefore, there is a need for a catalyst that eliminates catalyst-ionomer interactions to improve the performance of PEM fuel cell cathode catalysts.

### SUMMARY

One embodiment of the invention relates to a method of improving Faradaic efficiency in an electrochemical device. The method includes providing a catalyst at an electrode of the electrochemical device. The catalyst includes a nanoparticle comprising a metal or metal alloy. The nanoparticle is selected to improve catalytic performance in the electrochemical device. The catalyst further includes an electron-conductive nano-zeolitic framework encasing the nanoparticle. The nano-zeolitic framework includes a hollow three-dimensional framework defining a catalyst surface, an internal cavity in which the nanoparticle is disposed, and a plurality of pores extending through the nano-zeolitic framework. The plurality of pores have a size and shape selected to block molecules corresponding to undesired reactions in the electrochemical device. The method further includes selectively promoting a desired reaction at the catalyst surface and selectively blocking the undesired reactions at the catalyst surface.

Another embodiment of the invention relates to a method of synthesizing encased platinum nanoparticles in an electron-conductive hollow three-dimensional nano-zeolitic framework. The method includes forming a nano-zeolitic framework with a first reaction mixture comprising ZSM-5 cuboid nanocrystals and a platinum precursor and evaporating a solvent of the first reaction mixture under nitrogen flow to form Pt²⁺-ZSM-5. The method includes forming a hollow nano-zeolitic framework with a second reaction mixture comprising Pt²⁺-ZSM-5 and a structure directing agent and hydrothermally treating the second reaction mixture to form Pt²⁺@HZSM-5. The method includes encasing platinum nanoparticles in the hollow nano-zeolitic framework by injecting the Pt²⁺@HZSM-5with an NaBH₄ solution, forming Pt⁰@HZSM-5. The method includes coating the encased platinum nanoparticles in the hollow nano-zeolitic framework with LaₓO_{y}H, a conformal carbon deposition aid layer, by forming a third reaction mixture comprising Pt⁰@HZSM-5 and La(NO₃)₃·6H₂O and hydrothermally treating the third reaction mixture to form [Pt⁰@HZSM-5]@LaₓO_{y}H. The method includes applying a chemical vapor deposition process to deposit carbon on the [Pt⁰@HZSM-5]@LaₓO_{y}H and form electron-conductive [Pt⁰@HZSM-5]@LaₓO_{y}H@C. The method includes forming encased platinum nanoparticles in an electron-conductive hollow three-dimensional nano-zeolitic framework by acid etching the [Pt⁰@HZSM-5]@LaₓO_{y}H@C to remove the conformal carbon deposition aid layer, forming [Pt⁰@HZSM-5]@C.

Another embodiment of the invention relates to a method of synthesizing encased platinum nanoparticles in an electron-conductive hollow three-dimensional nano-zeolitic framework. The method includes forming hollow nano-zeolitic framework by forming a first reaction mixture comprising ZSM-5 and a structure directing agent and hydrothermally treating the first reaction mixture to form HZSM-5. The method includes performing an ion exchange treatment on the HZSM-5 with La(NO₃)₃·6H₂O to form La³⁺-HZSM-5. The method includes forming an electron-conductive hollow nano-zeolitic framework using chemical vapor deposition to deposit carbon on the La³⁺-HZSM-5 to form [LaₓO_{y}H-HZSM-5]@C. The method includes forming cavities within the electron-conductive hollow nano-zeolitic framework by acid treating the [LaₓO_{y}H-HZSM-5]@C to dissolve the LaₓO_{y} layer and form HZSM-5@C. The method includes encasing platinum nanoparticles in the electron-conductive hollow nano-zeolitic framework by forming a second reaction mixture comprising [Pt(NH₃)₄](NO₃)₂ and the HZSM-5@C, hydrothermally treating the second reaction mixture with the structure directing agent and reducing the second reaction mixture with an NaBH₄ solution to form [Pt⁰@HZSM-5]@C.

This summary is illustrative only and should not be regarded as limiting.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 shows transmission electron microscopy (TEM) images of a nanoengineered catalyst.

FIG. 2 shows scanning electron microscope (SEM) images of a ZSM-5 nanostructure in the presence and absence of Pt and Co cations.

FIG. 3 shows a flow chart of a method of synthesizing a nanoengineered catalyst utilizing sol-gel conformal coating aid for carbon deposition.

FIG. 4 shows a flow chart method of synthesizing a nanoengineered catalyst utilizing sol-gel component dissolution assisted cavity formation.

FIG. 5 shows a cyclic voltammogram (CV) showing the application of a nanoengineered catalyst and commercial catalysts in a CO₂ electrolyzer environment.

FIG. 6 shows a schematic illustration of the fabrication of encased platinum nanoparticles in electron-conductive hollow 3D nano-zeolitic frameworks through a sol-gel assisted formation of ultra-conformal coating aid for a carbon deposition method.

FIG. 7 shows a schematic illustration of the fabrication of encased platinum nanoparticles in electron-conductive hollow 3D nano-zeolitic frameworks through a sol-gel component dissolution assisted cavities formation method.

FIGS. 8A-8B show powder X-ray diffraction (PXRD) patterns of: (a) parent ZSM-5nanocuboids (ZSM-5), hollow ZSM-5 nanocrystals (HZSM-5), hollow ZSM-5 nanocrystals conformally coated with a thin layer of LaₓO_{y}H (HZSM-5@LaₓO_{y}H), reference ZSM-5 (JCPDS card no. 01-079-2401) reflecting the resilience and stability of a ZSM-5 mobil-type five (MFI) structure; and (b) magnification of an XRD 2-theta range between 30° and 45°.

FIGS. 9A-9B show PXRD patterns of: (a) electron-conductive ZSM-5 nanocrystals (ZSM-5@C), electron-conductive hollow ZSM-5 nanocrystals (HZSM-5@C), and encased platinum nanoparticles in electron-conductive hollow ZSM-5 nanocrystals ([Pt⁰@HZSM-5]@C), reference ZSM-5 (JCPDS card no. 01-079-2401) reflecting the resilience and stability of the ZSM-5 MFI structure; and (b) magnification of the XRD 2-theta range between 35° and 70° with respect to the reference cubic metallic platinum (JCPDS, card no. 01-089-7382).

FIGS. 10A-10D show TEM, high-angle annular dark-field scanning transmission electron microscopy (HAADF-STEM), simultaneous ADF-STEM micrographs of the encased platinum nanoparticles in hollow ZSM-5 nanocrystals Pt⁰@HZSM-5 (a, b, c), and the corresponding EDS elemental maps of silicon, platinum, and carbon.

FIGS. 11A-11F show: (a) secondary electron scanning transmission electron microscopy (SE-STEM) image (a) and HAADF-STEM image (inset a); (b) simultaneous ADF-STEM micrograph; (c) the corresponding carbon, lanthanum, silicon, and platinum EDS elemental maps of the hollow ZSM-5 nanocrystals control sample [HZSM-5@LaₓO_{y}H]@C after the ultra-conformal LaₓO_{y}H coating and CVD carbon deposition processes; (d) the encased platinum nanoparticles in conductive hollow nanocrystals [Pt⁰@HZSM-5]@LaₓO_{y}H@C SE-STEM image, HAADF-STEM image (inset d); (e) simultaneous ADF-STEM micrograph, HRTEM image (inset e); and (f) the corresponding EDS elemental maps of carbon, lanthanum, silicon, and platinum.

FIGS. 12A-12C show: (a) SE-STEM image; (b) corresponding EDS elemental maps of the electron-conductive hollow ZSM-5 nanocrystals (HZSM-5@C) after the cavity formation process through the dissolution of LaₓO_{y}H; and (c) HAADF-STEM of the resulting electron-conductive encased sample [Pt⁰@HZSM-5]@C.

FIGS. 13A-13D show: (a-b) SEM micrographs of the parent ZSM-5 nanocuboids ZSM-5; (c) TEM images of the corresponding hollow ZSM-5 nanocrystals HZSM-5; and (d) the encased platinum nanoparticles in hollow ZSM-5 nanocrystals [Pt^{0@}HZSM-5]@LaₓO_{y}H.

FIGS. 14A-14D show: (a) simultaneous ADF-STEM micrograph of the encased platinum sample Pt⁰@HZSM-5 after the second addition of platinum, (inset a) corresponding HAADF-STEM images; (b) EDS elemental maps of silicon and platinum; (c) ADF-STEM micrographs, (inset c) HAADF-STEM images; and (d) La, Si, Pt elemental maps of [Pt^{0@}HZSM-5]@LaₓO_{y}H.

FIG. 15 shows the oxidative decomposition of CVD carbon deposition precursor C₂H₄ over encased platinum nanoparticles samples La³⁺-[Pt⁰@HZSM-5 ] with two different platinum loadings 1.79 wt % Pt and 4.06 wt %.

FIG. 16 shows low magnification HAADF-STEM images and corresponding EDS spectrum of the resulting platinum film obtained when the sol-gel component dissolution assisted cavity formation method was applied to non-hollow electron-conductive ZSM-5 sample, ZSM-5@C.

FIG. 17 shows high magnification HAADF-STEM images of the resulting platinum film obtained when the sol-gel component dissolution assisted cavity formation method was applied to non-hollow electron-conductive ZSM-5 sample, ZSM-5@C.

FIGS. 18A-18B shows representative nitrogen adsorption-desorption isotherms of the prepared samples.

FIG. 19 shows a representative BJH-modeled pore size distribution plot of the prepared samples.

FIGS. 20A-20B show: (a) electron energy loss (EEL) spectra at C K edge of the [Pt⁰@HZSM-5]@La(OH)₃@C, zeolite derived carbon (CVD C) obtained after the dissolution of the ZSM-5 nanocrystals, and a reference amorphous carbon sample; and (b) the corresponding thermogravimetric analysis (TGA) of CVD carbon.

FIGS. 21A-21D show: (a) non-Faradaic CVs of electron-conductive HZSM-5@C; (b) a linear regression fit of the current density differences vs scan rates; (c) background- and iR-corrected ORR voltammogram for the encased catalyst; and (d) support AST (1.0 to 1.5 V vs RHE) in deaerated 0.1 M HClO₄500 mV/s.

FIG. 22 shows a schematic of a vertical plug-flow fused-quartz reactor.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to a nanoengineered catalyst designed to improve the Faradaic efficiency of energy conversion and electrolysis systems. The nanoengineered catalyst maintains and/or enhances the efficacy of electrochemical reactions in energy conversion/electrolysis systems, while also blocking unwanted reactions. The nanoengineered catalyst may be used in a broad range of applications, such as a fuel cell anode catalyst, fuel cell cathode catalyst, supercapacitor electrode material, carbon dioxide electrolysis anode catalyst, lithium-ion battery anode, and zeolite-based heterogeneous catalyst.

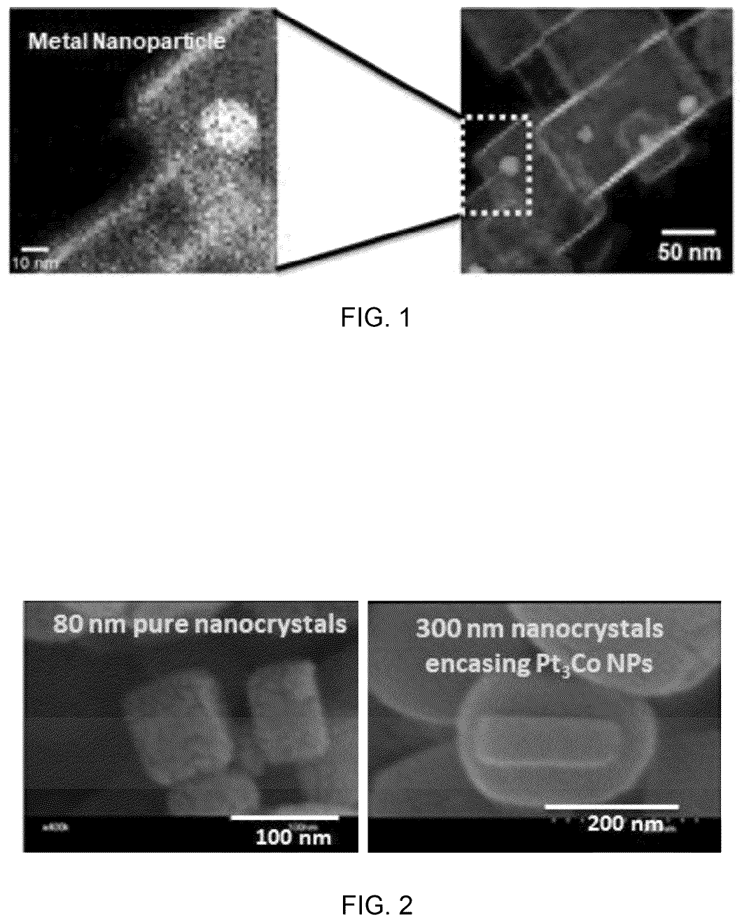

Referring to FIGS. 1-2 generally, a nanoengineered catalyst design includes a single metal nanoparticle or alloyed metal nanoparticle encased in an electron-conductive nano-sized hierarchically porous three-dimensional inorganic framework (e.g., electron conductive hollow 3-D inorganic nanocuboid). In some embodiments, the nanoparticle is a transition metal, such as a group 9 or group 10 transition metal, including being selected from a group of platinum (Pt), palladium (Pd), iridium (Ir), ruthenium (Ru), cobalt (Co), and/or nickel (Ni). In further embodiments, the nanoparticle is an alloy of the noble metals Pt, Pd, or Ru and the base metals Co and Ni. The hierarchically porous three-dimensional inorganic framework allows selective oxidation/reduction of desired ions/molecules at the catalyst surface and while also allowing selective blocking of redox reactions of unwanted intermediates/reactants/products.

In some embodiments, the nanoengineered catalyst is an encased catalytic metal nanoparticle in an electron-conductive hollow 3-D nano-zeolitic framework. In some embodiments, the nanoengineered catalyst is an encased platinum nanoparticle in electron-conductive hollow 3D nano-zeolitic framework. Zeolites are low-density microporous crystalline inorganic frameworks composed of aluminosilicates with high surface area and ordered pores with molecular diameters.

Hollow zeolite nanocrystals, zeolitic framework, are a unique class of zeolite materials that are characterized by a highly monodispersed size and shape. The small and uniform thickness of the hollow zeolite walls leads to enhanced mass transfer and diffusion properties and hence improved reaction rates with respect to conventional solid zeolites, especially in the liquid phase reactions. The zeolitic frameworks define a plurality of pores (e.g., cavities or channels). The pores have a shape and size that can be selectively controlled. Due to their large internal cavity, zeolitic framework can be used as nanoreactors to confine metal nanoparticles inside the nano-zeolitic framework that “size sort” molecules via a sieving-like mechanism where ions/molecules with a diameter smaller than the channels diameter are allowed to pass and larger species are excluded from the zeolite interior. Hollow zeolitic frameworks hinder the adsorption of poisonous species (e.g., ionomers) which deactivate the metal nanoparticles catalyst, and possess superior sintering, leaching, and aggregation resistance. Pore size of the nanoengineered catalyst is determined based on the application of the nanoengineered catalyst. Once determined, based on available data of pore size for each class of zeolite, a zeolite with a specific pore size tailored to that application is selected.

Electron-conductive frameworks are crucial for electrocatalysis, energy storage, and energy conversion applications. However, zeolites are poor electron conductors (about 10⁻⁸ S/cm vs. >100 S/cm graphene) and do not fulfill this criterion for practical applications. Thus, for electrochemical applications, the non-electron conductive zeolite must be converted to be electron-conductive. The high catalytic activity of noble metal nanoparticles, especially platinum nanoparticles and their ability to destructively oxidize ethylene at low temperatures, represents an obstacle toward the synthesis of encased noble metal nanoparticles in electron-conductive hollow zeolites. The presence of nanoparticles (e.g., Pt) will oxidize any carbon deposition to improve electron conductivity. There are no reports of the synthesis of electron-conductive nano-zeolite crystals, electron-conductive hollow zeolite nanocrystals, and encased noble metal nanoparticles in electron-conductive hollow zeolite nanostructures. The nanoengineered particle is synthesized using an ultraconformal carbon deposition aid layer around the surface of the zeolite, allowing carbon to be deposited to improve electron-conductivity. In some embodiments, the ultraconformal carbon deposition aid layer is LaₓO_{y}. The presence of an electron-conductive framework in the nanoengineered catalyst opens up research in areas such as electrocatalysis, energy conversion, and energy storage.

In some embodiments, the nanoengineered catalyst works as a cathode catalyst in proton exchange membrane fuel cells (PEMFCs). Platinum and platinum alloy nanoparticles supported on high-surface-area carbon substrate, are typically used as the cathode catalyst in PEMFCs. At the cathode of a PEMFC, oxygen reduction reaction (ORR) takes place. An ionomer conducts protons from the anode to the cathode. By their nature, PEMFCs are comprised of an acidic membrane and have an acidic ionomer binder in the anode and cathode catalyst layers. The acidic ionomer can degrade the cathode catalyst, in particular if the cathode catalyst has a base metal component. Further, the ionomer may inhibit catalyst activity and impair oxygen reduction reaction kinetics, particularly at high current densities and low catalyst loadings. Therefore, while acidic environments are essential for proton conductivity, the acidic environments in PEMFCs may also exacerbate detrimental cathode catalyst-ionomer interactions, compromising the performance, durability, and reliability of the PEMFC.

To address issues of ionomer poisoning of ORR activity, local oxygen transport resistance, and lack of cathode performance durability, the pore size of the nanoengineered catalyst is less than 2 nm and greater than 0.346 nm. The molecular diameter of oxygen is about 3.46 Å (0.346 nm), and perfluorosulfonic acid (PFSA) ionomer forms rod-like particles with diameters of about 2 nm-2.5 nm in the solutions used to make PEMFC electrodes. Therefore, the zeolite cage in the nanoengineered catalyst is selected to exclude PFSA ionomer but allow the passage of oxygen, water, proton, and electrons to and from the catalyst particles inside the cages.

In some embodiments, the nanoengineered catalyst may be Pt catalyst particles encased in ZSM-5 zeolite. Encasing the Pt catalyst particles eliminates direct contact between corrosion-catalyst catalyst nanoparticles and carbon. Therefore, the nanoengineered catalyst eliminates issues of ionomer poisoning and local oxygen transport resistance related to direct contact between the ionomer and catalyst surface, as well as prevents loss of catalyst surface area resulting from particle migration and coalescence and carbon corrosion-related degradation. The nanoengineered catalyst eliminates cathode catalyst-ionomer interactions in PEMFCs, significantly improving the performance of the PEMFC.

In some embodiments, the nanoengineered catalyst works as an anode catalyst in CO₂ electrolyzers. At the anode of CO₂ electrolyzers, oxidation of a species occurs. At the cathode, reduction of CO₂ takes place. Different reduction products may be formed, depending on desired output, such as carbon monoxide (CO), methane (CH₄), or formic acid (HCOOH). In some embodiments, the nanoengineered catalyst eliminates catalytic reaction of the CO₂RR value-add chemical products, such as formate, at the anode of a CO₂ electrolyzer by blocking diffusion of the product to the anode catalyst in the CO₂ electrolyzer. Unintended transfer of formate ions from the cathode to the anode (“formate crossover”) can lead to a decrease in the efficiency of the CO₂ electrolyzer. At the anode, formate may undergo oxidation. Formate crossover may reduce yield of formate, contaminate the anode, or impact the purity of the formate produced at the cathode. The nanoengineered catalyst blocks the oxidation of crossover formate at the anode of a CO₂ electrolyzer allowing for its recovery from the anode effluent, therefore improving the Faradaic efficiency of the CO₂ electrolyzer.

In some embodiments, the nanoengineered catalyst works as a cathode analyst in alcohol fuel cells (Direct Methanol Fuel Cells (DMFCs), Direct Ethanol Fuel Cells (DEFCs), etc.). In some embodiments, the nanoengineered catalyst works as a cathode catalyst in DMFCs. At the anode of DMFCs, methanol is oxidized. At the cathode, oxygen is reduced. Unintended diffusion of methanol from the anode to the cathode (“methanol crossover”) can result in the loss of methanol from the anode, and also decrease the rate of methanol oxidation, thereby lowering the overall power output, fuel utilization efficiency, and cell efficiency of the fuel cell. Methanol crossing over to the cathode can undergo incomplete oxidation reactions and poison the cathode, degrading its performance and further reducing the efficiency of the fuel cell. In addition, methanol crossover can depolarize the cathode of DMFCs. In some embodiments, the nanoengineered catalyst prevents/eliminates methanol crossover at the cathode. In some embodiments, the elimination of methanol crossover increases the power output of DMFCs aby about 30%, making the DMFC more viable for portable application.

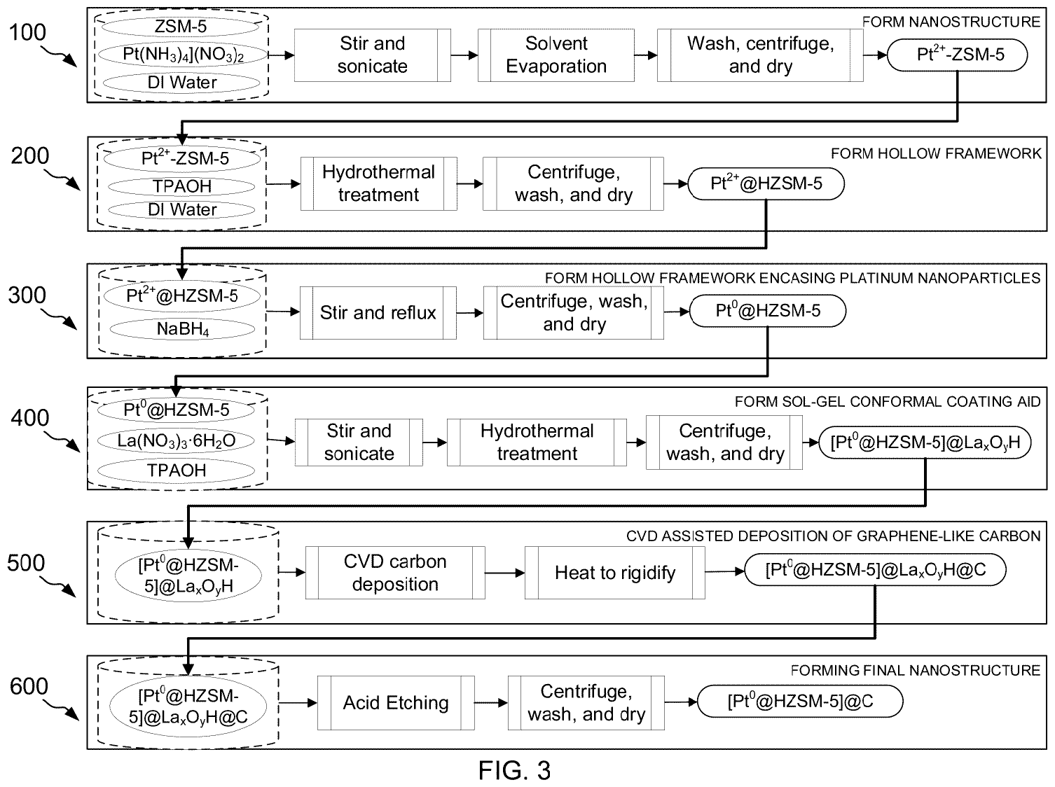

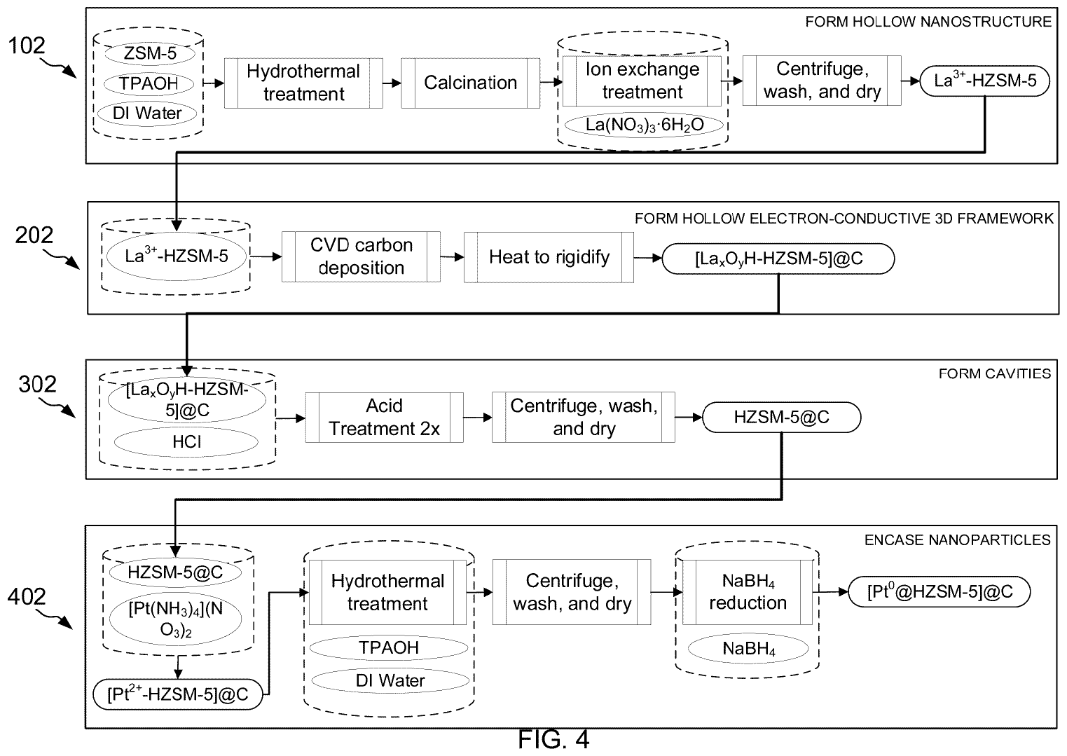

The methods illustrated in FIGS. 3-4 relate to scalable methods of synthesizing the nanoengineered catalyst utilizing inorganic sol-gel chemistry, seed-mediated synthesis, nanoengineered etching, and chemical vapor deposition (CVD). In general, a nanostructure is formed as a zeolitic framework. The nanostructure is then further processed to form a hollow zeolitic framework. The hollow nanostructure is further treated to reduce a transition metal to metal nanoparticles within the hollow nanostructure. The hollow nanostructure encasing the metal nanoparticles is then coated with an ultraconformal layer of a material that aids in the catalytic decomposition of a hydrocarbon, such as an alkene/alkyne, to carbon, thus forming a conformal carbon layer. The resultant material is further processed, such as to remove the hydrocarbon decomposing aid material, resulting in a catalytic material comprising platinum nanoparticles within electron-conductive hollow zeolite structures.

The hydrocarbon decomposition aid material is composed of a sol-gel layer. The sol-gel layer is nonporous and blocks the pores of the zeolite and prevents direct contact between the metal nanoparticles (e.g., Pt) inside the zeolite and the carbon deposition precursor, which can be oxidized if it interacted with metal nanoparticles. The sol-gel layer also acts as a catalyst and template to deposit carbon where it reacts with the carbon deposition precursor.

Generally, the synthesis methods discussed further below start with the formation of the following seeds: ZSM-5 nanocuboids, hollow nanocuboid crystals HZSM-5, Pt⁺@HZSM-5, and encased platinum nanoparticles in hollow 3D nano-zeolitic frameworks Pt⁰@HZSM-5 through modified ion exchange, impregnation, dissolution, recrystallization, chemical reduction, and sol-gel hydrothermal processes.

FIG. 3 illustrates a first scheme for synthesizing the nanoengineered catalyst utilizing sol-gel conformal coating aid for carbon deposition. This method forms an ultra-conformal coating aid for graphene-like carbon deposition to enable the synthesis of encased metal nanoparticles in electron conductive hollow 3-D inorganic nanocuboids. In some embodiments, the method includes forming an ultra-conformal sol-gel coating layer of LaₓO_{y}H around encased platinum nanoparticles in hollow 3D nano-zeolitic frameworks Pt⁰@HZSM-5. As illustrated in FIG. 3, step 100 includes forming a nanostructure (e.g., Pt²⁺-ZSM-5) using ZSM-5 cuboid nanocrystals, platinum precursor (e.g., [Pt(NH₃)₄](NO₃)₂), and deionized (DI) water and heating under a flow of nitrogen gas to evaporate the solvent. In step 200, a hollow framework (e.g., Pt² @HZSM-5) is formed by adding a structure directing agent (e.g., TPAOH) and DI water to the Pt²⁺-ZSM-5 and hydrothermally treating the reaction mixture (e.g., with a Parr reactor). Step 300 includes forming a hollow framework encasing the metal nanoparticle (e.g., Pt⁰@HZSM-5) by processing an aqueous suspension of Pt^{2+@}HZSM-5 with NaBH₄. Step 400 includes forming the sol-gel conformal coating aid (e.g., [Pt⁰@HZSM-5]@LaₓO_{y}H). In step 400, a precursor for the ultra-conformal coating layer (e.g., La(NO₃)₃·6H₂O) is processed with an aqueous suspension of the Pt⁰@ZSM-5 and a structure directing agent (e.g., TPAOH), and the reaction mixture is hydrothermally treated. The hydrothermal treatment of Pt⁰@HZSM-5 in the presence of excess La³⁺ ions and TPAOH as a surface directing agent under basic conditions results in the formation of a thin layer of oxygen-rich La(OH)₃ denoted as LaₓO_{y}H, that ultra-conformally coats the Pt⁰@HZSM-5 nanocrystals to produce [Pt⁰@HZSM-5]@LaₓO_{y}H hybrid nanostructure. LaₓO_{y}H is a mixture of La(OH)₃ and La₂O₃. Values for x may range from 1-3, and values for y may range from 3-6. Step 500 includes the formation of [Pt⁰@HZSM-5]@LaₓO_{y}H@C by using CVD for carbon deposition and heat processing to rigidify the CVD deposited carbon frameworks. Electron-conductive hollow ZSM-5 nanocrystals are produced by applying the CVD carbon deposition process to HZSM-5@LaₓO_{y}H. Lastly, step 600 includes forming the final nanostructure (e.g., [Pt⁰@HZSM-5]@C) by acid etching (e.g., using hydrochloric acid (HCl)) to remove the LaₓO_{y}H layer.

FIG. 4 illustrates a second scheme for synthesizing the nanoengineered catalyst utilizing sol-gel component dissolution assisted cavity formation. This method utilizes sol-gel layer dissolution assisted cavity formation for nanoparticles encasing to produce yolk-shell electron-conductive nanostructures. In some embodiments, the cavities are formed through the dissolution of a LaₓO_{y}H sol-gel layer. As illustrated in FIG. 4, step 102 includes forming a hollow nanostructure (e.g., La³⁺-HZSM-5) by adding a structure directing agent (e.g., TPAOH) and DI water to the Pt²⁺-ZSM-5 and hydrothermally treating the reaction mixture (e.g., with a Parr reactor) and performing ion exchange treatment with La(NO₃)₃·6H₂O. The hydrothermal treatment of the ZSM-5 solid nanocuboid crystals in the presence of TPAOH as a surface directing agent results in the formation of hollow ZSM-5 single nanocrystals HZSM-5 through a series of dissolution and recrystallization processes. In step 202, hollow electron-conductive three-dimensional frameworks (e.g., [LaₓO_{y}H-HZSM-5]@C) are formed by applying CVD for carbon deposition on La³⁺--HZSM-5 nanocrystals and heat processing. This results in a highly electron-conductive hollow 3D nano-zeolitic framework. In step 302, cavities are formed by treating [LaₓO_{y}H-HZSM-5]@C with HCl and processing the mixture. The acid treatment results in the formation of cavities or tunnels within the electron-conductive hollow nano-zeolitic framework due to the dissolution of the LaₓO_{y}component. In step 402, the metal nanoparticles are encased by adding Pt²⁺ ions (e.g., using aqueous solution of [Pt(NH₃)₄](NO₃)₂) and treating the product with a structure directing agent (e.g., TPAOH) and hydrothermally treating the reaction mixture (e.g., with a Parr reactor). Further, in step 402, after hydrothermal treatment, the product is processed with NaBH₄ to form the encased product [Pt⁰@HZSM-5]@C.

### EXPERIMENTAL RESULTS

The following section describes experimental examples. These examples are merely illustrations and should not be construed as limiting the disclosure.

### I. CO₂ Electrolyzer Environment

The nanoengineered catalyst and two commercial catalysts (metal nanoparticles and metal loaded on carbon) were tested in an aqueous cell mimicking the CO₂ electrolyzer anode environment of room temperature Ar-saturated 0.1 M KOH+0.3 M formate. Formate is employed as a representation of CO₂ electroreduction value-added products. When the commercial catalysts were applied, formate oxidation was observed. When the nanoengineered catalyst was applied, no formate oxidation was observed.

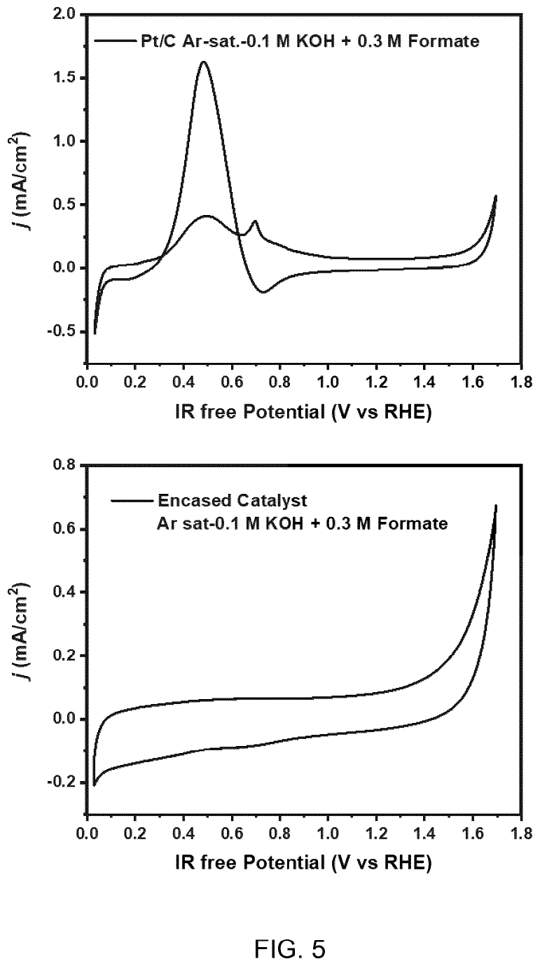

FIG. 5 depicts iR-corrected cyclic voltammograms (CVs) of the commercial Pt/C catalysts and the nanoengineered catalyst. CVs were collected at a scan rate of 10 mV/s and RDE rotation rate of 1600 rpm, with potentials reported with respect to the reversible hydrogen reference electrode (RHE). As shown, the nanoengineered catalyst successfully blocked formate oxidation on the anode catalyst of a CO₂ electrolyzer without suppression of the desired oxygen evolution reaction.

### II. Synthesis of Encased Noble Metal Nanoparticles in Electron-Conductive Hollow 3D Nano-Zeolitic Frameworks

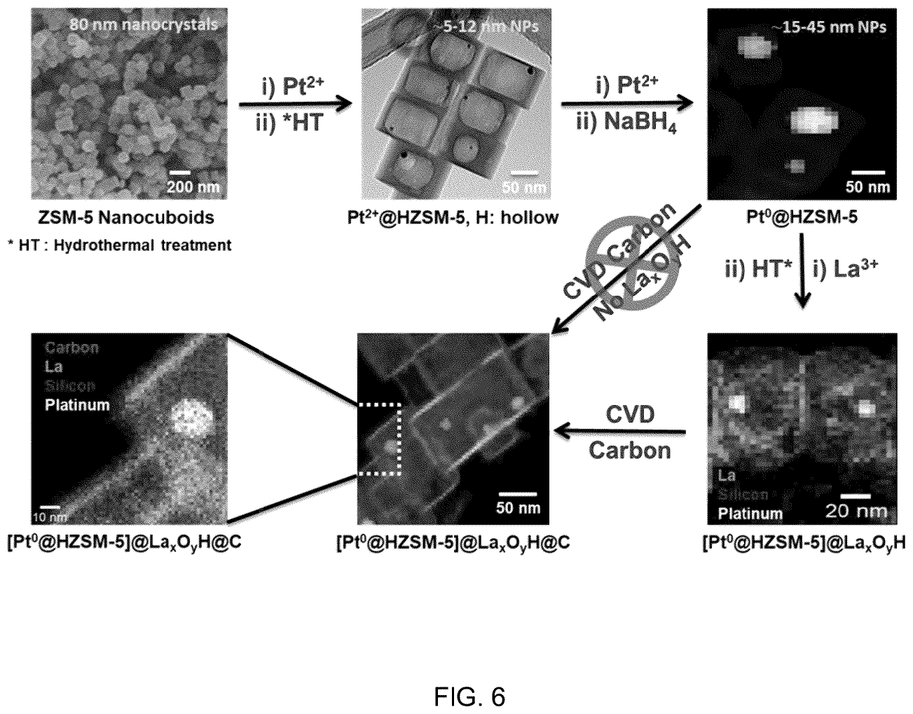

FIGS. 6-21 illustrate examples and results relating to a generic and efficient gram scale synthesis of encased noble metal nanoparticles in electron-conductive hollow three-dimensional nano-zeolitic frameworks.

Materials. Sodium aluminate (NaAlO₂, anhydrous, analytic reagent) and tetraethyl orthosilicate (TEOS, ≥99.0%) were used as alumina and silica source, respectively. Tetrapropylammonium hydroxide (TPAOH, 1.0 M aqueous solution) was used as the structure directing agent. Tetraammineplatinum (II) nitrate [Pt(NH₃)₄](NO₃)₂ 99.995% trace metals basis used to grow platinum nanoparticles. Lanthanum (III) nitrate hexahydrate La(NO₃)₃·6H₂O was the precursor for the ultra-conformal coating layer. Ultra-high-purity ethylene (Airgas, EY UHP200) was employed as precursor for the CVD carbon deposition process. Hydrochloric acid HCl (Fisher, Certified ACS Plus) was diluted to 5.0 M and used in the reaction products workup. Type I Millipore Milli-Q ultrapure water (18.2 MΩ·cm at 25° C.) used for all the synthesis reactions.

Synthesis of 3D zeolitic nanocuboids. Gram scale amounts of cuboid ZSM-5nanocrystals were produced using a Teflon-lined Parr reactor. To synthesize 7.0 grams of ZSM-5 nanocuboids, a clear sol was made by mixing 3.7 mmol of NaAlO2 and 24.2 mmol of aqueous TPAOH at 400 rpm for 30 min. at ambient conditions. 92.2 mmol of TEOS was added dropwise to the clear sol and allowed to mix at room temperature and 400 rpm for 30 min. Then, it was transferred to an oil bath at 80° C. and stirred at 400 rpm. After 4 hr., the heat turned off and the stirring continued for 24 hr. The as-prepared gel solution was transferred into a Teflon-lined Parr reactor to undergo a hydrothermal crystallization reaction at 180° C. under static conditions. After 72 hr., the heat was turned off and the reactor cooled down overnight. The resulting product was collected by centrifugation at 8000 rfc for 20 min., washed with deionized water 3×, ethanol 1×, and dried under vacuum at 120° C. for 12 hr. To remove the unreacted aluminum ions, the dried product was treated with 50 mL of 5.0 M HCl solution/1.0 g solid product at 60°° C., 400 rpm for 6 hr. and then recovered by centrifugation, washed with deionized water 5×, ethanol 1× and vacuum dried at 120° C. overnight. The 3D ZSM-5 nanocuboid crystals were obtained after removing the structure directing agent via calcination of the dried product in a horizontal tube furnace at 550° C. under an atmosphere of air for 6 hr.

### Example 1—Sol-Gel Conformal Coating Aid for Carbon Deposition Method

FIG. 6 is a schematic illustration of the example synthesis of encased platinum nanoparticles in electron-conductive hollow 3D nano-zeolitic frameworks through the sol-gel assisted formation of ultra-conformal coating aid for carbon deposition method.

### Synthesis

Fabrication of Pt²⁺-ZSM-5 nanostructure. 5 g ZSM-5 cuboid nanocrystals were outgassed under vacuum at 300° C. for 12 hr. A 10 mL aqueous solution of platinum precursor tetraammineplatinum (II) nitrate [Pt(NH₃)₄](NO₃)₂ containing a predetermined platinum loading (e.g. 5.0 wt %) was added dropwise with constant stirring of 400 rpm to the outgassed ZSM-5nanocuboids followed by the addition of 20 mL of deionized water. The reaction mixture was then stirred for 30 min., sonicated for 30 min., refluxed in an oil bath for 2 hr., allowed to evaporate under nitrogen flow, and further dried in vacuo overnight. The dried product underwent 6 cycles of rigorous washing where each gram of the dried product was dispersed in 30 mL of water 5×, ethanol 1×, vortexed for 3 min., centrifuged at 8000 rfc for 20 min., and then dried under vacuum at 60° C. for 12 hr.

Fabrication of the hollow framework Pt²⁺@HZSM-5. 4.15 mL of 1.0 M TPAOH and 3.35 mL of deionized water were added per gram of Pt²⁺-ZSM-5 and stirred in a 50° C. oil bath at 400 rpm for 60 min. The reaction mixture was transferred to a Teflon-lined Parr reactor and heated at 180° C. under static conditions for 72 hr. After cooling to ambient temperature, the reaction product was centrifuged at 8000 rfc for 20 min, washed with deionized water 3× and ethanol 1×, and dried under vacuum at 60° C. for 12 hr.

Fabrication of hollow nano-zeolitic framework encasing platinum nanoparticles Pt⁰@HZSM-5. An ice-cold aqueous solution of NaBH₄ (molar ratio of NaBH₄:Pt²⁺ ions is 20:1) was injected rapidly into a freshly prepared 30 mL aqueous suspension of Pt^{2+@}HZSM-5under vigorous stirring. The mixture was stirred for 1 hr. at ambient conditions and then refluxed for 2 hr. The product was collected by centrifugation, washed with deionized water 3× ethanol 1×, and dried in vacuo at 60° C.

Fabrication of sol-gel conformal coating aid for carbon deposition [Pt⁰@HZSM-5]@LaₓO_{y}H. 10 mL of aqueous La(NO₃)₃·6H₂O was added dropwise with vigorous stirring to a 15 mL aqueous suspension of Pt⁰@ZSM-5 (Si:La³⁺ mole ratio is 1.5:1), stirred for 10 min., and then sonicated for 30 min. Under vigorous stirring, 11 mL of 1.0 M TPAOH was added dropwise to the reaction mixture (PH˜9) and stirred for 30 min. The reaction mixture was then transferred into a Teflon-lined Parr reactor to undergo hydrothermal treatment at 180° C. for 12 hr. The product was collected by centrifugation, washed with ethanol 3× and dried in vacuo at 80° C.

CVD assisted deposition of graphene-like carbon [Pt⁰@HZSM-5] @LaₓO_{y}H@C. The carbonization and graphitization processes were performed in a home built vertical plug-flow fused-quartz reactor of 0.5 inch (≤1.0 g [Pt⁰@HZSM-5]@LaₓO_{y}H) or 1.0 inch (1.0-5.0 g [Pt⁰@HZSM-5]@LaₓO_{y}H) internal diameter equipped with a fritted quartz disk in a vertical tubular furnace. The reaction gas flow rate is controlled by three mass flow controllers fixed at 30 mL/min. In a typical graphene-like carbon deposition synthesis, a pre-determined amount (0.05-5.0 g) of the sample is loaded into the vertical plug-flow reactor and its temperature is controlled by a K-type thermocouple located about 1 mm below the quartz disk holding the sample. At ambient temperature, the system is flushed with argon (Ar, 30 ml/min.) and ethylene (C₂H₄, 30 mL/min.) mixture for an hour to remove oxygen from the system and deacrate the deionized water in the humidifier. The gas flow through the humidifier was turned off and the temperature of the reactor was increased to 650° C. at a heating rate of 5° C./min. and allowed to stabilize at 650° C. for an hour under dry argon flow of 30 mL/min. Thereafter, the ethylene gas was flowed at 30 mL/min. through a low-flow humidity bottle assembly maintained at ambient temperature and combined with the argon flow (30 mL/min.) before reaching the sample bed. The carbon deposition reaction allowed to proceed for 2 hr. at 650° C. where the color of the sample changed from grey to black. The ethylene and water vapor feed was then stopped, gas flow was subsequently switched back to dry argon, and temperature of the reactor was increased to 900° C. at 5° C./min. and maintained for 2 hr. to rigidify the CVD deposited carbon frameworks and produce [Pt⁰@HZSM-5] @LaₓO_{y}H@C nanostructure.

### Control Experiments

A first control experiment was performed to examine the possibility of using the hollow zeolitic framework as a nanoreactor by repeating the procedure used to fabricate the Pt²⁺-ZSM-5 nanostructure.

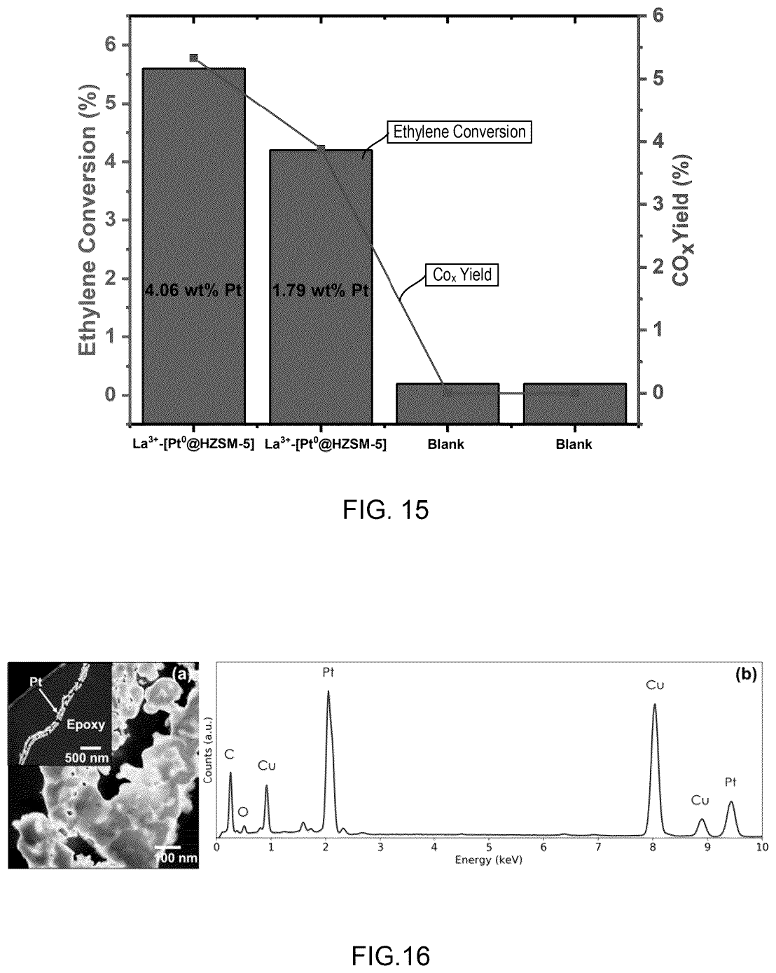

In a second control experiment, Pt⁰@HZSM-5 underwent two ion exchange processes using a 0.5 M aqueous solution of La(NO₃)₃·6H₂O. The reaction product La³⁺-[Pt⁰@HZSM-5] was subjected to CVD carbon deposition using argon, ethylene, and water vapor according to the protocol used for CVD assisted deposition of graphene-like carbon [Pt⁰@HZSM-5] @LaₓO_{y}H@C. The control experiment was performed as follows: 20 mg of the prepared sample was load into a 16-channel high-throughput fixed bed system (Flowrence® from Avantium), and the reactor temperature was increased to 600° C. at a heating rate of 10° C./min. under a flow of 10% C₂H₄/Ar+100 μL/min. water. The reaction products were monitored by means of gas chromatography using an Agilent 7890B GC analyzer. The results are shown in FIG. 15.

Control experiments highlighted the significant role and dual function of the sol-gel ultra-conformal coating layer during the deposition of the sp2 hybridized carbon. The absence of the sol-gel ultra-conformal coating layer resulted in the catalytic oxidation of the carbon deposition precursor to carbon monoxide and carbon dioxide over the platinum nanoparticles and hence failure of the CVD carbon deposition. Control experiments also demonstrated that the presence of the sol-gel ultra-conformal coating layer is essential for the formation of the electron-conductive [Pt⁰@HZSM-5]@C nanostructure.

### Example 2—Sol-Gel Component Dissolution Assisted Cavity Formation Method

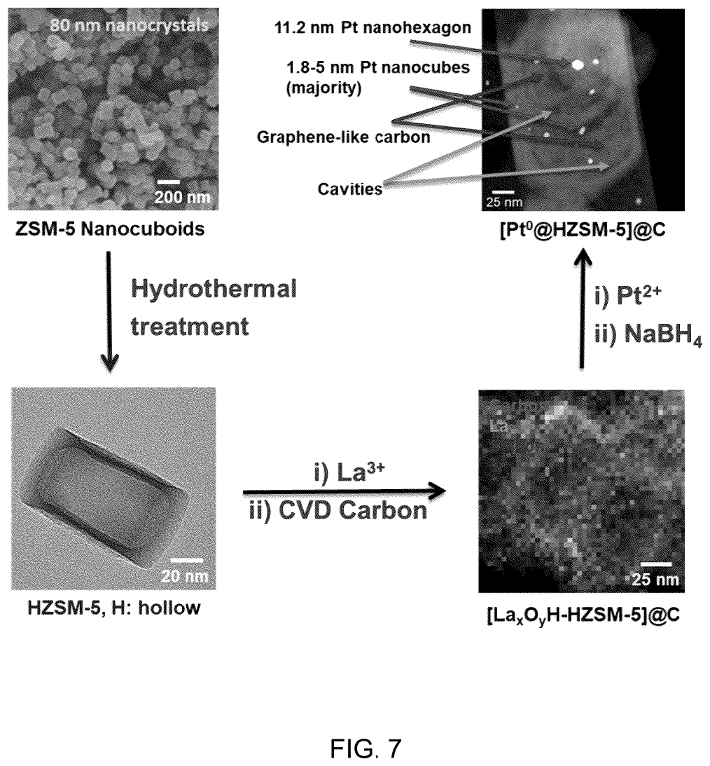

FIG. 7 is a schematic illustration of the synthesis of encased platinum nanoparticles in electron-conductive hollow 3D nano-zeolitic frameworks through the sol-gel component dissolution assisted cavities formation method.

### Synthesis

Fabrication of hollow La³⁺-HZSM-5 nanostructure. Hollow ZSM-5 nanocrystals denoted as HZSM-5 were obtained upon the treatment of the ZSM-5 nanocuboids with 1.0 M TPAOH following the same protocol applied to fabricate Pt²⁺-ZSM-5 nanostructure and calcined in air at 600° C. for 6 hr. An ion exchange treatment of the hollow ZSM-5 nanocrystals with a 0.5 M aqueous solution of La(NO₃)₃·6H₂O at 80° C. and 400 rpm overnight was repeated twice and the product was collected by centrifugation, washed with deionized water 3× and dried in vacuo at 80° C.

Formation of hollow electron-conductive zeolitic nanocrystals LaₓO_{y}H-HZSM-5@C. The carbonization and graphitization procedures used in CVD assisted deposition of graphene-like carbon were used on the La³⁺-HZSM-5 nanocrystals. Highly electron-conductive hollow 3D nano-zeolitic frameworks of [LaₓO_{y}H-HZSM-5]@C were obtained.

Cavities formation and encasing of platinum nanoparticles [Pt⁰@HZSM-5] @LaₓO_{y}H@C. The [LaₓO_{y}H-HZSM-5]@C was treated twice with 5.0 M HCl at 60° C. for 2 hr. The resulting cavities-rich product HZSM-5@C was recovered by centrifugation, washed with deionized water 5×, and dried in vacuo at 80° C. The addition of 5 wt % Pt²⁺ ions to HZSM-5@C was achieved by using an aqueous solution of [Pt(NH₃)₄](NO₃)₂. The hydrothermal treatment of the product [Pt²⁺-HZSM-5]@C with an aqueous solution of TPAOH followed by NaBH₄ reduction resulted in the formation of the encased product [Pt⁰⁺-HZSM-5]@C.

### Control Experiment

In order to examine the importance of the HCl treatment and validate the importance of removing the sol-gel lanthanum layer to create cavities that assist the formation of the electron-conductive encased platinum, the process for cavity formation and encasing of platinum nanoparticles was repeated without the application of the HCl treatment. The hydrothermal treatment of the product [Pt²⁺-LaₓO_{y}H-HZSM-5]@C with an aqueous solution of TPAOH resulted in the formation of large free standing platinum film with 3 cm length.

The control experiments demonstrated the viability of the cavity formation method for encasing platinum nanoparticles in the HZSM-5 nanocuboids.

### Characterization

### Powder X-Ray Diffraction (PXRD) Analysis

Powder X-ray diffraction (PXRD) patterns were acquired at ambient conditions using a Bruker D8 Discover diffractometer equipped with a Cu Kα radiation source, λ=1.54 Å, at an operating voltage of 40 kV and 40 mA operating current to determine the phase purity, phase chemical composition, and crystal structure of as-synthesized parent ZSM-5 and different materials derived from it, during the fabrication of the electron-conductive encased platinum nanoparticles nanostructures. Diffractograms were recorded in θ-2θ geometry from 5° to 80° with a step size of 0.02° and step time of 1 s. Crystal phase identification was performed using X'Pert Highscore Plus software equipped with ICDD/JCPDS database. The relative crystallinity of the prepared samples was evaluated by calculating the integrated area of the XRD peaks between 22.5° and 25°.

### Microscopy

The morphology, elemental composition, and elements spatial distribution of the prepared samples were investigated before and after the CVD carbon deposition process by electron microscopy tools. The samples were first analyzed using a field emission scanning electron microscope (JEOL JSM-7500F) with a 5 kV acceleration voltage and a field emission transmission electron microscope (JEOL JEM-2100F) with a 200 kV acceleration voltage. STEM images and spectroscopic data were acquired on an aberration-corrected JEOL NEOARM STEM equipped with a cold field emission gun, a dual 100 mm² SDD EDS detector system, and a Gatan 965 GIF Quantum ER Imaging Filter EELS spectrometer. The instrument was operated at 200 kV with a semi-convergence angle of ˜28 mrad and probe current of ˜30 pA. For STEM images and EDS maps, pixel dwell times of 32 μs and 50-100 ms were used, respectively. The C K-edge EELS data were summed from spectrum images over entire structures, acquired with a pixel dwell time of 100 ms and a dispersion of 0.25 eV per channel. Images and spectroscopic data were analyzed and display using the Python libraries Numpy and Matplotlib. EDS elemental maps were generated by integrating X-ray signal from the C K-edge and the Si, La, and Pt L-edges.

### Textural Measurements

The textural properties of the prepared samples were determined by collecting nitrogen adsorption-desorption isotherms on a Micromeritics ASAP-2020 surface area and pore size analyzer. Approx. 200 mg of each sample was outgassed in a cell at 350° C. under vacuum for 6 hours prior to analysis. The Brunauer-Emmett-Teller (BET) model was implemented to calculate the surface area of the prepared samples, whereas fitting the nitrogen desorption isotherms using Barrett-Joyner-Halenda (BJH) model was utilized to calculate pore size, cumulative pore volume, and pore size distributions.

### Thermogravimetric Analysis (TGA)

In order to identify the nature of the CVD deposited carbon, the thermal decomposition of the zeolite-derived carbon (CVD C) sample was investigated using a thermogravimetric analyzer (Discovery TA-Instruments) under nitrogen atmosphere up to 1000° C.

### Inductively Coupled Plasma-Optical Emission Spectroscopy (ICP-OES)

The platinum content in the encased electron-conductive zeolitic nanostructures was measured by using Perkin Elmer Optima 8300DV inductively coupled plasma-optical emission spectroscopy (ICP-OES) system. The samples were acid-digested using HNO₃, HCl, and HF.

### Electrochemical Measurements

The electron conductivity, oxygen reduction reaction (ORR) activity, and durability of the electron-conductive nano-zeolitic samples, corresponding encased platinum sample, and a control non-encased platinum sample were investigated by cyclic voltammetry (CV) measurements. The CV measurements were conducted in a standard three-compartment rotating disk electrode (RDE) electrochemical cell under ambient conditions using a CH Instruments potentiostat (Model 760C). Mercury/mercurous sulfate reference electrode (Hg/Hg₂SO₄, 0.5 M H₂SO₄) and high surface area counter electrode made of gold wire coil in a glass enclosure with a porous frit were employed. The Hg/Hg₂SO₄ reference electrode was calibrated against a reversible hydrogen electrode, RHE, and all potentials included in this work are reported with respect to the reversible hydrogen electrode.

Four samples (electron-conductive hollow zeolitic nanocrystals HZSM-5@C, non-encased platinum catalyst Pt⁰-ZSM-5, encased platinum catalyst Pt⁰@HZSM-5, and electron-conductive encased platinum catalyst [Pt⁰@HZSM-5]@C) were prepared and employed as working electrodes. The prepared working electrodes underwent potential cycling between 0.05 and 1.0 V vs RHE in deaerated 0.1 M HClO₄ (GFS Chemicals, Inc.) electrolyte at a sweep rate of 500 mV/s to electrochemically clean and activate the working electrode surface. Typically, 100 cycles were employed under a blanket of Argon gas to protect the electrolyte surface from atmospheric oxygen.

Non-Faradaic CVs of electron-conductive HZSM-5@C electrode were recorded in ultra-high purity argon-saturated 0.1 M HClO₄ (GFS Chemicals, Inc., Ar 99.994% purity, Air Gas) at different scan rates of 20, 50, 75, 100, 150, 200, 300, 400, and 500 mV/s to evaluate its electron-conductivity and calculated its double layer capacitance, C_{dl}.

To evaluate the oxygen reduction reaction (ORR) activity of the prepared electrodes, CV measurements were conducted using the thin film rotating disk electrode (TF-RDE) technique in oxygen-saturated 0.1 M HClO₄ electrolyte (GFS Chemicals, Inc., O₂ 99.994% purity, Air Gas) at 1600 rpm and a scan rate of 10 mVs⁻¹. The kinetic current (jₖ) associated with the ORR process was calculated from the recorded CV traces using the following formula (jₗᵢₘ and j are the measured limiting current and measured current at a specific potential, respectively):

$${j}_{k} = \frac{{j}_{lim} \times j}{( {j}_{lim} - 1 )} .$$

The mass activity of the prepared electrodes was calculated by normalizing the jx with respect to the platinum loading in the electrodes (18 μg-Pt cm⁻²).

The U.S. Department of Energy accelerated stress test (AST) for catalyst supports was applied to investigate the long-term stability of the CVD deposited carbon by cycling the [Pt⁰@HZSM-5]@C catalyst within the potential window 1.0 to 1.5 V vs RHE for 5,000 cycles at sweep rate of 500 mV/s in deaerated 0.1 M HClO₄. CVs were collected at the beginning and end of the test in oxygen-saturated 0.1 M HClO₄ electrolyte at 1600 rpm and a scan rate of 10 mVs⁻¹ to measure the changes in the ORR mass activity of the catalyst.

### RESULTS

### Sol-Gel Assisted Formation of Ultra-Conformal Coating Aid for Carbon Deposition Method

Referring to FIG. 6, the hydrothermal treatment of Pt⁰@HZSM-5 in the presence of excess La³⁺ ions and TPAOH as a surface directing agent under basic conditions resulted in the formation of a thin layer of oxygen-rich La(OH)₃ denoted as LaₓO_{y}H, with an average thickness of 5 nm that ultra-conformally coats the Pt⁰@HZSM-5 nanocrystals to produce [Pt⁰@HZSM-5]@LaₓO_{y}H hybrid nanostructure. The nano-thick layer of LaₓO_{y}H suppresses the interaction between the chemical vapor deposition (CVD) carbon deposition precursor C₂H₄ and the encased platinum nanoparticles. It also serves as a carbon deposition aid and template during the CVD process. In a home-built vertical plug-flow fused-quartz reactor maintained at 650° C., the carbon deposition aid LaₓO_{y}Hcatalyzes the conversion of the ethylene gas into graphitic carbon in the presence of water vapor. Within a short period of time, the carbon growth over the nanocuboid crystals can be visually observed, where the grey color of the [Pt^{0@}HZSM-5]@LaₓO_{y}H sample changes to black [Pt^{0@}HZSM-5]@LaₓO_{y}H according to the following reaction mechanism: first, lanthanum carbide LaₓC_{y} is produced upon the interaction between the ethylene gas and the carbon deposition aid LaₓO_{y}H at 650° C. Second, the resulting carbide is subsequently reacted with water vapor and converted back into LaₓO_{y}H during the carbon deposition process. The resulting electron-conductive material [Pt^{0@}HZSM-5]@LaₓO_{y}H@C undergoes another heat treatment at 900° C. to solidify the deposited carbon and improve its degree of graphitization.

$${La}_{x} {O}_{y} H {\to }^{{C}_{2} {H}_{4}} {La}_{x} {C}_{y} {\to }^{{H}_{2} O} {La}_{x} {O}_{y} H + {C}_{growth}$$

### Sol-Gel Component Dissolution Assisted Cavities Formation Method

The hydrothermal treatment of the ZSM-5 solid nanocuboid crystals at 180° C. in the presence of TPAOH as a surface directing agent resulted in the formation of hollow ZSM-5 single nanocrystals HZSM-5 through a series of dissolution and recrystallization processes. The hollow La³⁺-HZSM-5 nanostructure is obtained upon the ion exchange treatment of the hollow ZSM-5 nanocuboids with La (NO₃)₃·6H₂O solution and then is allowed to undergo a carbonization process in the presence of ethylene gas and water vapor in a vertical plug-flow fused-quartz reactor maintained at 650° C. Graphitization of the CVD deposited carbon was performed under argon atmosphere at 900° C. to produce a highly electron-conductive product [LaₓO_{y}H-HZSM-5]@C. The acid treatment of resulting product with 5.0 M HCl at 60° C. resulted in the formation of cavities or tunnels within the electron-conductive hollow nano-zeolitic framework due to the dissolution of the LaₓO_{y}H component. The treatment of the cavity-rich product with an aqueous solution of [Pt(NH₃)₄](NO₃)₂ followed by hydrothermal treatment in the presence of TPAOH allowed the penetration of the Pt²⁺ ions into the hollow zeolitic nanostructure through the nanoengineered cavities and tunnels within the [cavity-rich-HZSM-5]@C hybrid nanostructure, and so encasing of the Pt²⁺ species within the electron-conductive nano-zeolitic framework. Wet chemical reduction of the product using NaBH₄ resulted in the formation of [Pt⁰@HZSM-5]@C encased catalytic material.

### Structural, Compositional, and Morphological Investigations

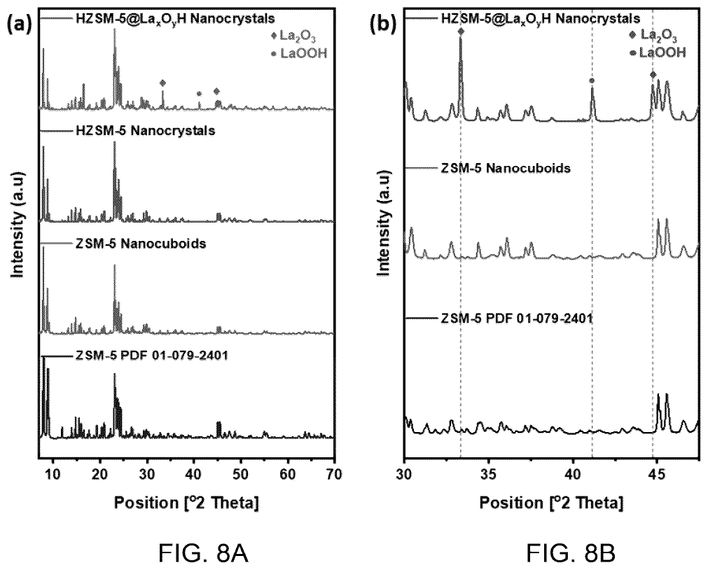

X-ray diffraction and microscopic imaging investigations of the reaction products indicated the formation of pure, well-dispersed, and highly crystalline solid nanocuboid crystals with average size of 80×125 nm. These nanostructures successfully maintained their morphology after the hydrothermal dissolution and recrystallization processes which resulted in the formation of the hollow structure which itself successfully retained its microstructure and topology after the addition, encasing, and reduction of platinum ions as shown in FIGS. 8-12 and discussed in the following sections.

### Resilience and High Stability

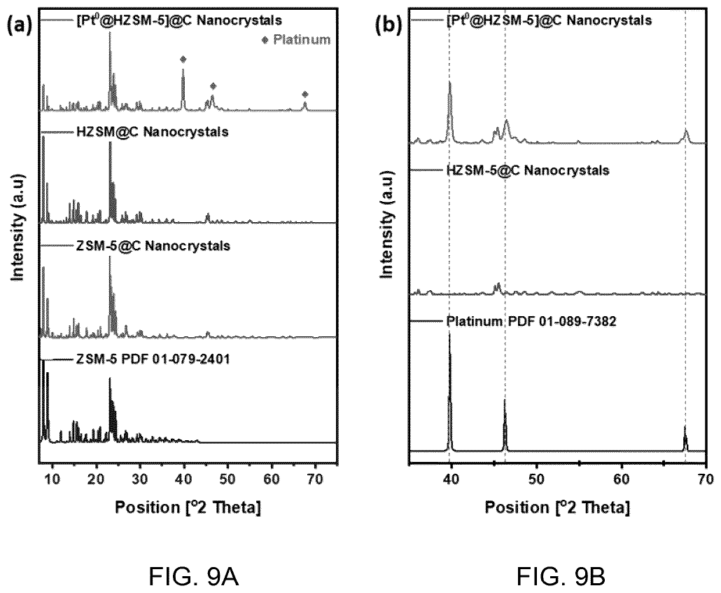

FIGS. 8-9 show the powder X-ray diffraction (PXRD) patterns of parent ZSM-5 nanocuboids (ZSM-5), hollow ZSM-5 nanocrystals (HZSM-5), hollow ZSM-5 nanocrystals ultra-conformally coated with a thin layer of LaₓO_{y}H (HZSM-5@LaₓO_{y}H), electron-conductive ZSM-5 nanocrystals (ZSM-5@C) obtained after the acid etching of LaₓO_{y}H, electron-conductive hollow ZSM-5 nanocrystals (HZSM-5@C), and encased platinum nanoparticles in electron-conductive hollow ZSM-5 nanocrystals ([Pt^{0@}HZSM-5]@C). All the lanthanum-frec electron-conductive materials were obtained after the acid etching of LaₓO_{y}H. Three sets of diffraction peaks are identified in the collected XRD patterns, each of which provides insight into the composition of the examined samples and the efficacy of the established synthesis protocols. All the synthesized materials displayed seven diffraction peaks located at 7.92°, 8.78°, 23.06°, 23.27°, 23.69°, 26.91°, and 24.39° that can be indexed to the diffraction from the (101), (200), (332), (051), (151), (303), and (313) planes of ZSM-5 zeolite with a typical MFI structure (JCPDS card no. 01-079-2401), respectively. This finding indicates that the as-prepared electron-conductive nanocrystals retained the MFI structure after the ion exchange, impregnation, dissolution, recrystallization, Pt²⁺ ions reduction, LaₓO_{y}H conformal coating, and carbon deposition processes at 650° C. and 900° C. This demonstrates the high stability and resilience of the prepared ZSM-5 nanocrystals. The formation of pure and highly crystalline solid nanocuboid single crystals is confirmed by the absence of any impurity diffraction peaks in the XRD pattern of ZSM-5 nanocuboids and hollow ZSM-5 nanocrystals as depicted in FIG. 8.

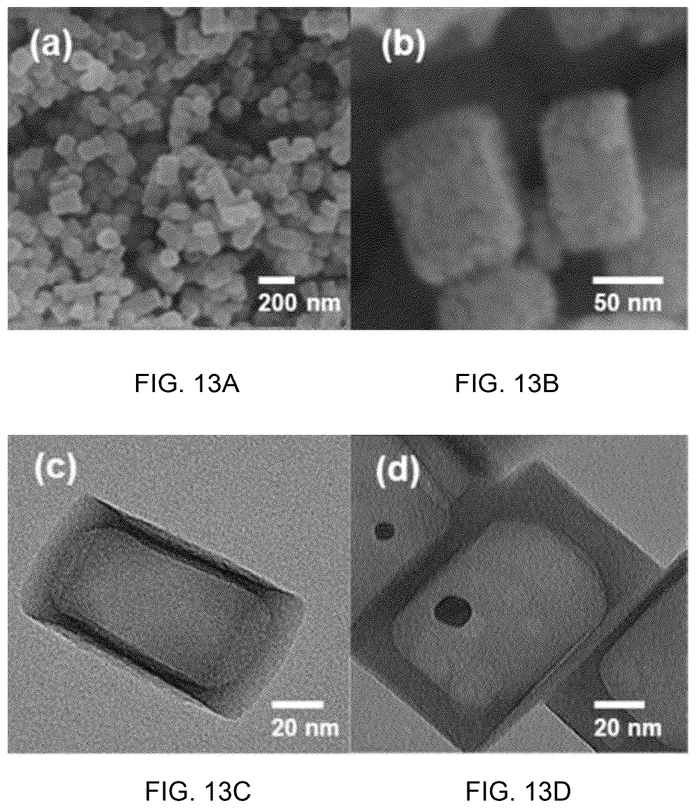

The SEM and TEM images in FIG. 13 confirm the formation of well-dispersed and highly crystalline ZSM-5 and hollow ZSM-5 (HZSM-5) crystals with a nanocuboid morphology and average size of 80×125 nm. The XRD data and the microscopy imaging clearly indicate the improved relative crystallinity of the hollow nanocrystals and electron-conductive samples (displayed higher area under the 2-theta region 22.5° to 25°) compared to the parent ZSM-5 nanocuboids which could be attributed to the hydrothermal treatment's rapid dissolution and slow recrystallization processes, as well as the high temperatures implemented during the formation of the electron-conductive ZSM-5 samples.

### Accessible and Sintering Resistance Encased Pt Nanoparticles

A closer examination of the XRD data in FIG. 9 indicated the presence of a second set of diffraction peaks located at 39.76°, 46.23°, and 67.45°, which corresponds to the (111), (200), and (220) lattice planes of metallic platinum with (JCPDS, card no. 01-089-7382). The platinum diffraction peaks in the encased sample exhibited a slight positive shift towards higher 2-theta angles which can be attributed to the encasing effect and formation of yolk-shell nanostructure as shown in FIG. 9B.

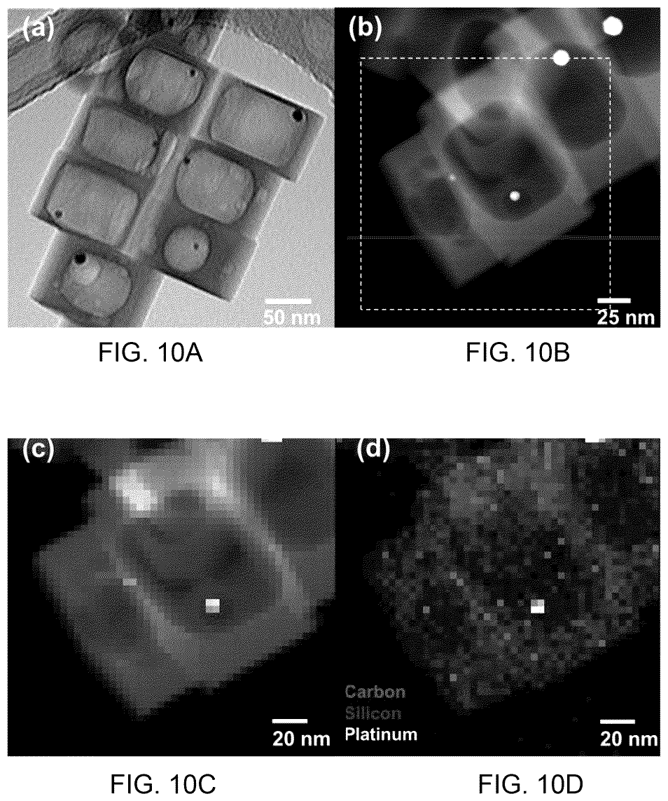

The TEM images in FIG. 13 and FIG. 10 revealed the successful encasing of platinum nanoparticles in hollow ZSM-5 nanocuboids to produce Pt⁰@HZSM-5 hybrid nanostructure. This finding, along with the XRD results (metallic platinum diffraction peaks) reveal that the interior of the hollow ZSM-5 nanocrystals as well as the platinum ions encased in the hollow structure are accessible as indicated by the change in color of the Pt²⁺@HZSM-5 sample from grey to black upon its reduction with an ice-cold aqueous solution of NaBH₄ during the formation of Pt⁰@HZSM-5 hybrid nanostructure due to the ZSM-5 porous framework. The encased platinum nanoparticles displayed a spherical shape with a particle size ranging from 5 to 12 nm and an average particle size of 8.4 nm.

To further examine the accessibility of the Pt²⁺ ions in the hollow ZSM-5 nanocage as well as the possibility of using the hollow zeolitic framework as a nanoreactor to synthesize more complex nanostructured materials, the Pt²⁺@HZSM-5 sample was subjected to a second dose of 5 wt % Pt aqueous solution, [Pt(NH₃)₄](NO₃)₂. The impregnated sample was subjected to hydrothermal treatment at 180° C. and subsequently reduced using aqueous NaBH₄ solution.

The transmission electron microscopy (TEM), high-angle annular dark-field scanning transmission electron microscopy (HAADF-STEM), simultaneous ADF-STEM micrographs, and the corresponding EDS elemental maps of silicon, platinum, and carbon (FIG. 9) of the resulting sample shows that the encased platinum nanoparticles attained a hexagonal morphology after the second platinum addition.

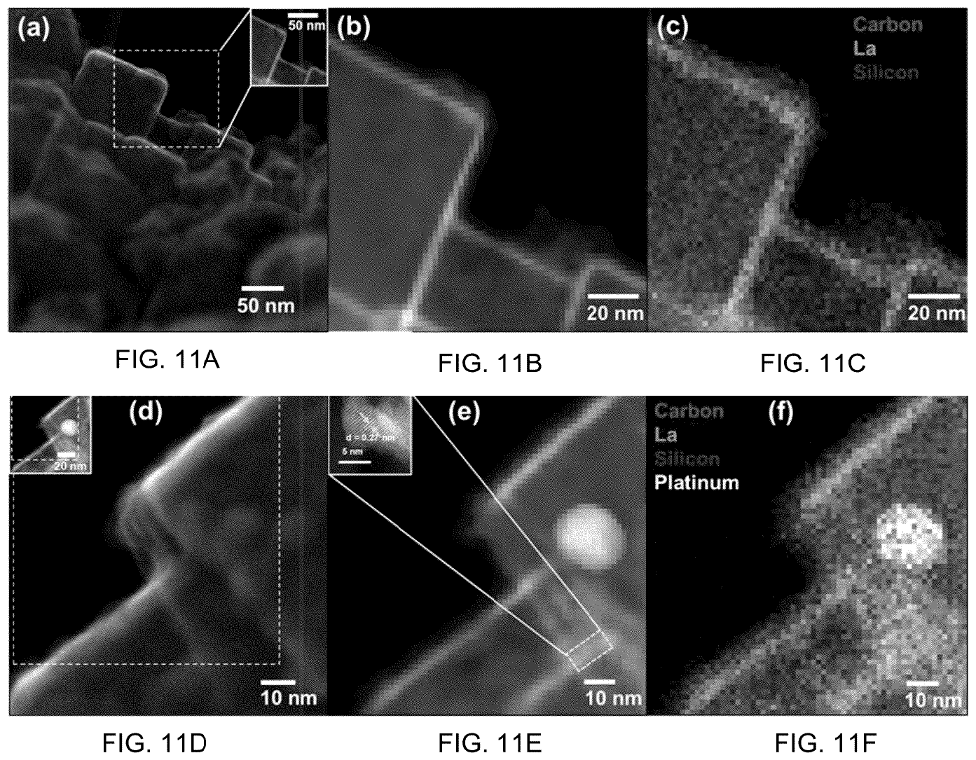

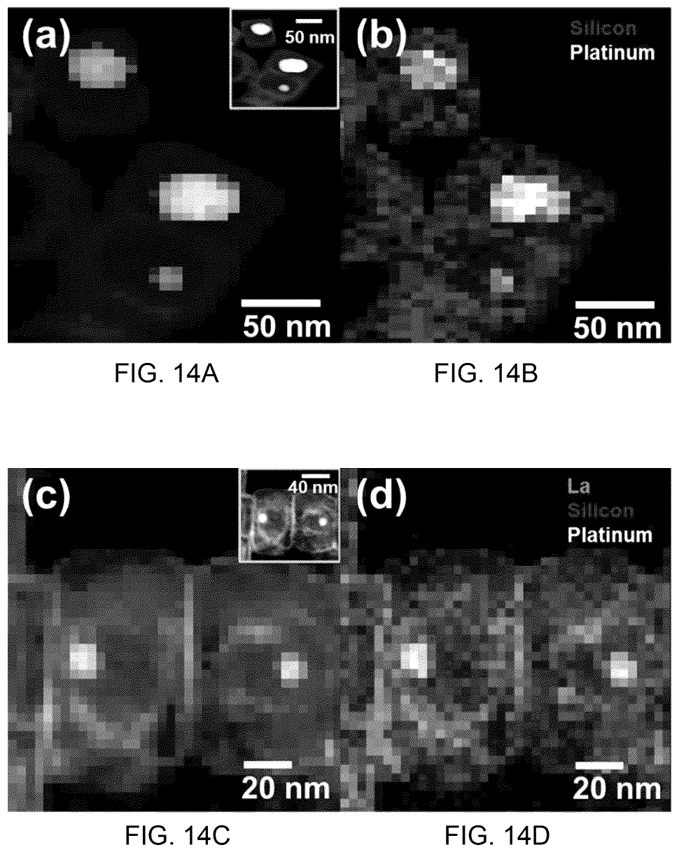

Careful analysis of the TEM data revealed that the second platinum dose significantly increased the size of the encased platinum nanoparticles to 15-45 nm, with an average size of 30 nm. The observed growth of the encased platinum nanoparticles provides further evidence that the encased species are accessible through the nano-zeolitic framework's pores, enabling the formation of encased alloyed nanoparticles composed of multiple metals. The average size of the encased platinum nanoparticles in the electron-conductive zeolitic nanocrystals that underwent heat treatment at 900° C. is 20 nm (FIG. 14, FIG. 11E, and FIG. 11F) which indicates the high thermal stability and the sintering resistance capability of the encased platinum nanoparticles. The demonstrated high thermal stability of the ZMS-5 nanocages and the relatively large size of the encased platinum nanoparticles compared to the pore size of the MFI nanostructures (5-45 nm vs. 5.5 Å) had an effective impact on suppressing the migration and sintering of the platinum nanoparticles during the different heat treatments required for the formation of the electron-conductive hybrid nanostructures. These images demonstrate the feasibility of using these hollow zeolitic frameworks as nanoreactors to run reactions in a confined nano-sized environment.

### Sol-Gel Ultra-Conformal Coating Carbon Deposition Aid

Hydrothermal treatment at 180° C. and PH ˜9 for 12 h in the presence of an aqueous La(NO₃)₃·6H₂O solution with a Si:La³⁺ mole ratio of 1.5:1 was employed to ultra-conformally coat the hollow ZSM-5 nanocrystals (HZSM-5) and encased platinum nanoparticles in hollow ZSM-5 nanocrystals [Pt^{0@}HZSM-5] with a thin lanthanum-based layer to endow the CVD carbon deposition process. The simultaneous ADF-STEM images and the EDS elemental maps of the materials depicted in FIG. 14 and FIG. 11 signify the success of the ultra-conformal coating process, where the resulting nanocrystals are characterized by the presence of ˜5 nm thick shell of oxygen rich lanthanum hydroxide (LaₓO_{y}H). It worthwhile to mention that the LaₓO_{y}H sol-gel layer is conformally covering the entire nanocrystals (FIG. 14) and the formation of a thin conformal surface layer of ˜5 nm think becomes more pronounced after the annealing process at 600° C., as displayed in FIG. 11. Three diffraction peaks corresponding to the formation of oxygen-rich lanthanum hydroxide ultra-conformal coating can be identified in the XRD pattern of the resulting samples, FIG. 8B. The XRD diffraction peaks positioned at interplanar angles of 33.3° and 44.81° can be attributed to the diffraction from the (411) and (440) planes of cubic La₂O₃ (JCPDS card no. 03-065-3185), respectively. While, the third diffraction peak at 41.03° can be indexed to (−201) crystal plane of LaOOH (JCPDS card no. 019-0656). The inset of FIG. 11E shows a high-resolution TEM image of the ultra-conformal lanthanum coating. The lattice fringes of the hydrothermally deposited conformal shell have a d-spacing of 0.27 nm, which can be indexed to either the (411) face of La₂O₃ (JCPDS card no. 03-065-3185) or the (200) plane of La(OH)₃ (JCPDS card no. 36-1481). This finding is consistent with the XRD data analysis results and support the formation of an oxygen rich lanthanum hydroxide (LaₓO_{y}H) coating layer.

### CVD Assisted Deposition of Graphene-Like Carbon

The La³⁺ ions in La³⁺-ZSM-5 or La³⁺-HZSM-5 nanocrystals catalyzed the conversion of the ethylene gas into graphitic carbon in the presence of water vapor to produce electron-conductive ZSM-5 and electron-conductive hollow ZSM-5 nanocrystals, as shown in FIGS. 8-9 and 11-12. This is the first report of the formation of electron-conductive hollow zeolitic nanocrystals. This pioneering CVD carbon deposition approach was not transferable to the La³⁺-[Pt⁰@HZSM-5] catalyst system and failed to produce electron-conductive encased platinum catalysts. The failure of the carbon deposition process was indicated by the fact that not only the electron conductivity of the sample did not improve but also the grey color of the sample did not change to black over the course of the CVD process. To better understand the reaction mechanism, reason for the reaction failure, shed light on the role of the LaₓO_{y}H sol-gel ultra-conformal coating layer, and verify its significance, the La³⁺ catalyzed CVD carbon deposition process was repeated in a high-throughput fixed bed system (Flowrence® from Avantium) and products of the reaction between the La³⁺-[Pt⁰@HZSM-5] and ethylene in the presence of water vapor were monitored using a gas chromatography (GC) analyzer. The obtained GC data in FIG. 15 illustrate the oxidative decomposition of ethylene to carbon monoxide and carbon dioxide over the platinum nanoparticles. These findings agree with previous reports about the catalytic oxidation of ethylene over platinum nanoparticles. The GC results further evidence that the hollow zeolitic nanocage encasing the platinum nanoparticles can be utilized as a nanoreactor and further verify the accessibility of the encased platinum nanoparticles to the reactant molecules. This understanding of the reasons for the failure of the CVD carbon deposition reaction on La³⁺-[Pt⁰@HZSM-5] resulted in the development of two novel strategies for the formation of electron-conductive [Pt⁰@HZSM-5]@C catalysts: a) the sol-gel conformal coating aid for carbon deposition method, and b) the sol-gel component dissolution assisted cavity formation method.

The first approach to induce the CVD carbon deposition on Pt⁰@HZSM-5 nanocrystals is based on the formation of a sol-gel oxygen-rich lanthanum hydroxide (LaₓO_{y}H) ultra-conformal coating layer. As a proof-of-concept, and to validate the establishment of an ultra-conformal sol-gel LaₓO_{y}H coating layer around the hollow ZSM-5 nanocrystals (HZSM-5) and its utilization as carbon deposition aid: Electron-conductive hollow ZSM-5 nanocrystals were produced by applying the CVD carbon deposition process to HZSM-5@LaₓO_{y}H sample, as shown in FIGS. 11A-11C. The obtained microcopy images show the success of the CVD carbon deposition process. The success of the CVD process was expected due to the absence of platinum nanoparticles and presence of lanthanum carbon deposition catalyst. However, it reveals significant information about the thickness of the ultra-conformal coating layer, and the thinness of the deposited carbon layer which are important for adjusting the different reaction parameters. Replacing the La³⁺-[Pt⁰@HZSM-5] sample (where the CVD reaction failed) by [Pt⁰@HZSM-5]@LaₓO_{y}H sol-gel ultra-conformal coating sample resulted in the success of the CVD carbon deposition process as evidenced by the EDS elemental maps, HR-TEM, SE-STEM, HAADF-STEM, and simultaneous ADF-STEM micrographs of the electron-conductive encased platinum nanoparticles sample [Pt⁰@HZSM-5]@LaₓO_{y}H@C produced by the ultra-conformal coating aid for carbon deposition method and displayed in FIG. 11 and FIG. 6. The success of the ultra-conformal coating method in depositing carbon on Pt⁰@HZSM-5 nanocrystals is evident by the formation of an about 4 nm thick carbon layer, FIG. 11F. It is clear that the nanocuboid morphology of the parent zeolite is maintained, the size of the hollow ZSM-5 nanocrystals, and the size of the encased platinum particles did change in the resulting catalyst. This demonstrates the important function of the LaₓO_{y}H ultra-conformal coating layer not only as a carbon deposition aid and template but also as a suppressor for the carbon precursor oxidation and decomposition during the CVD carbon deposition process.

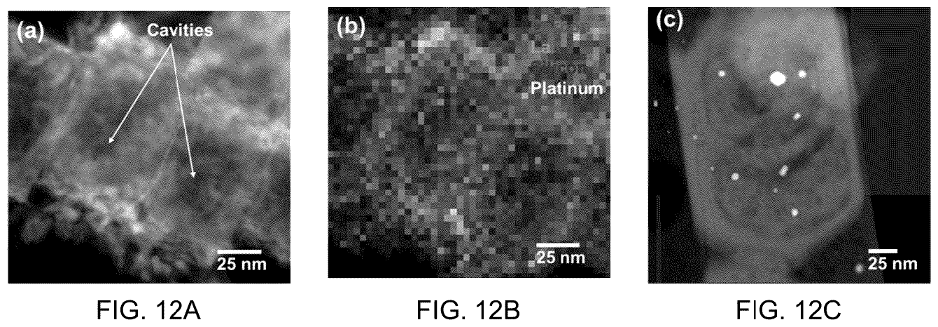

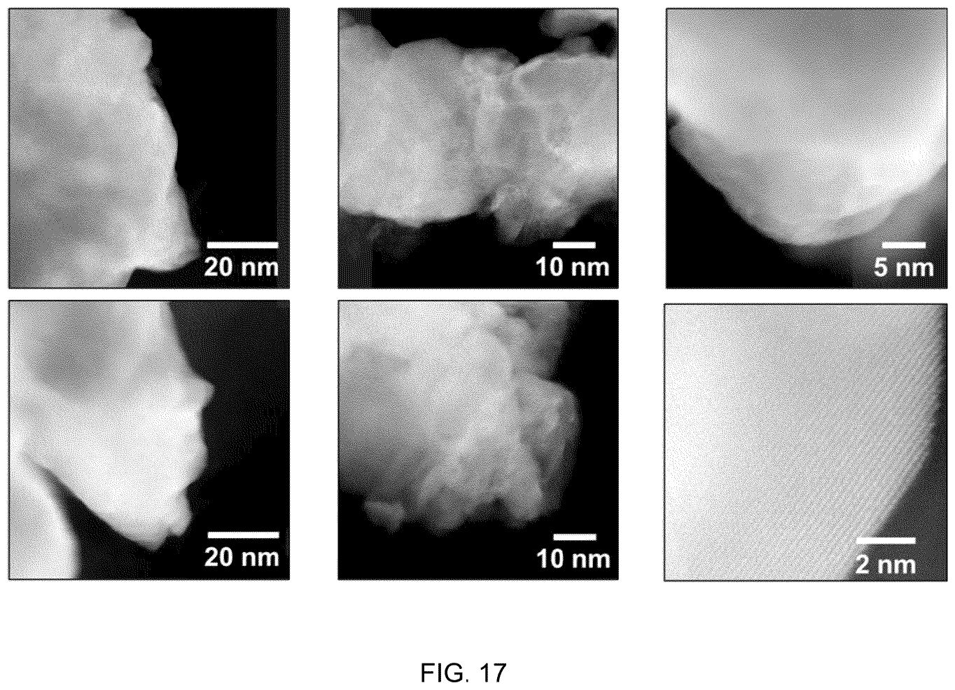

To further avoid the oxidative decomposition of the CVD carbon deposition precursor over the encased platinum nanoparticles during the formation of the electron-conductive encased platinum catalyst, the sol-gel component dissolution assisted cavity formation method was employed, FIG. 7. The microscopy images in FIG. 12 show that the generated cavities and tunnels within the electron-conductive hollow ZSM-5 nanocrystals successfully facilitated the encasing of platinum nanoparticles. The encased platinum nanoparticles displayed a semi-spherical shape and were between 1.8 and 5 nm in size, with a few nanohexagons of ˜ 11 nm. Encasing the platinum nanoparticles in cavity-free (no cavities) electron-conductive hollow ZSM-5 nanocrystals failed and produced instead a non-porous free standing platinum film. FIG. 16 and FIG. 17 exhibit the EDS spectrum and HAADF-STEM images of the resulting platinum film. This proof-of-concept experiment highlights how crucial it is to nanoengineer cavities and tunnels in the electron-conductive hollow ZSM-5 nanocrystals (HZSM-5@C) to enable the successful encasing of the platinum nanoparticles. Engineering the cavities and tunnels was only possible in the electron-conductive hollow ZSM-5 nanocrystals and not in the electron-conductive ZSM-5 nanocrystals (ZSM-5@C).

### Ultra-Conformal Coating and Sample Porosity

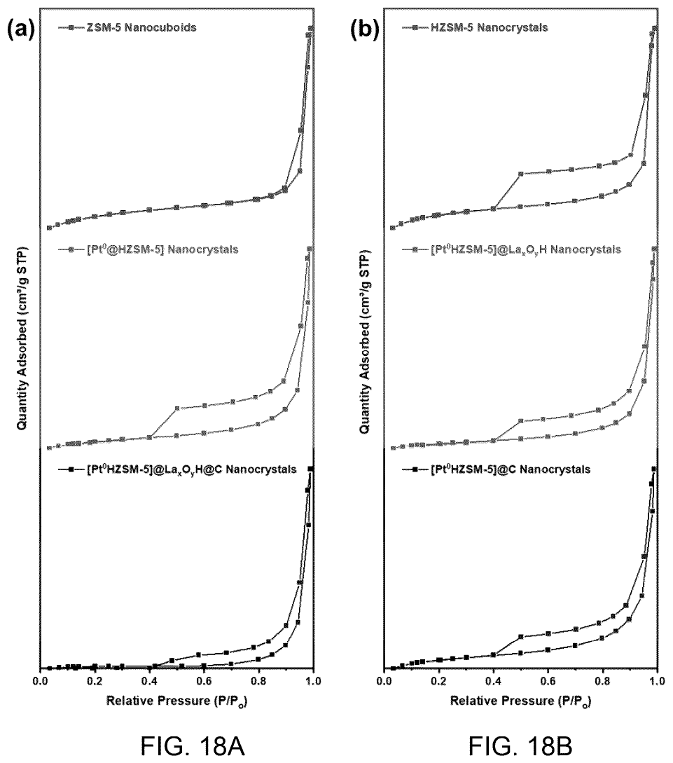

To gain a better understanding of the critical role of the LaₓO_{y}H ultra-conformal coating layer as carbon deposition aid and the reason for the failure of the CVD carbon deposition process when the La³⁺-[Pt⁰@ZSM-5] sample was applied, it was essential to shed the light on the porous textural properties of the generated samples. FIG. 18 shows representative N₂ adsorption-desorption isotherms of the examined samples. The parent ZSM-5 nanocuboids and the samples derived from it displayed features of type IV isotherms with hysteresis loop characteristic of mesoporous materials, according to IUPAC classifications.

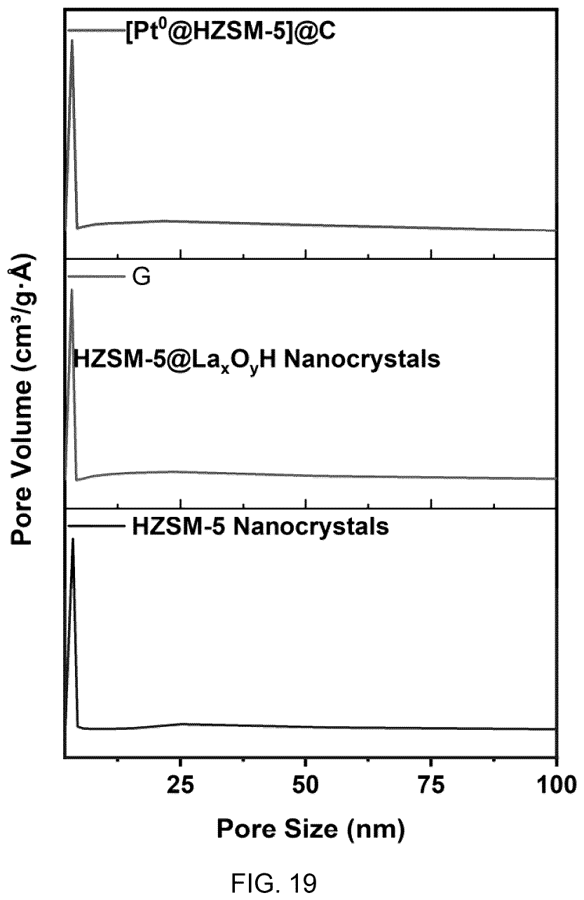

The hysteresis loop in the parent ZSM-5 sample isotherm at P/0=0.9−1.0 reveals the presence of aggregated mesopores originating from the nanocuboids aggregation as shown in the SEM images in FIG. 13. The mesoporosity of the nanocrystals was improved after the hydrothermal treatment with the N₂ isotherm of the hollow ZSM-5 nanocrystals showing a remarkable H4-shaped hysteresis loop with respect to the parent sample located at P/P0=0.4−1.0, indicating the successful formation of the hollow crystals as confirmed by the microscopy images. Absence of significant microporosity in the nanocuboid walls is supported by the lack of any sharp N₂ uptake at low relative pressure (P/P0<0.01) in the recorded isotherms. The pore diameter and pore size distribution were calculated from the nitrogen desorption isotherms using Barrett-Joyner-Halenda (BJH) model. As can be seen in FIG. 19, the BJH-modeled pore size distribution curves of the prepared samples are characterized by a sharp peak centered at 3.5 nm, indicating their narrow pore size distribution and mesoporous nature. Additionally, a broad and low intensity peak centered at 25.7 nm was observed. This broad peak may be attributed to the inter-particular voids. The cumulative pore volume of the prepared samples displayed a median value of 0.22 cm³/g Å. These mesoporous textural characteristics are maintained over the different reaction transformations implemented to encase the platinum nanoparticles in the electron-conductive ZSM-5 hollow nanostructures, which further support the high stability and resilience of the ZSM-5 MFI nanostructure.

The detailed textural parameters of the examined samples are summarized in the table below.

| | BET | Langmuir | Pore |
|---|---|---|---|
| | surface area | surface area | volume |
| Sample | (m²/g) | (m²/g) | (cm³/g) |
| ZSM-5 nanocuboids | 425.54 | 567.78 | 0.377 |
| HZSM-5 Nanocrystals | 345.68 | 459.64 | 0.28 |
| La³⁺-ZSM-5 | 401.56 | 536.22 | 0.33 |
| LaₓO_{y}H-ZSM-5@C | 80.18 | 108.73 | 0.21 |
| HZSM-5@LaₓO_{y}H | 71.19 | 96.75 | 0.25 |
| [Pt⁰@HZSM-5] @LaₓO_{y}H@C | 50.259 | 67.10 | 0.18 |
| [Pt⁰@HZSM-5]@C obtained | 122.34 | 164.29 | 0.17 |
| after HCl treatment | | | |
| Pt0@HZSM-5 | 151.23 | 202.40 | 0.22 |
| ZSM-5@C | 114.76 | 154.01 | 0.17 |

Brunauer-Emmett-Teller (BET) surface area of the parent ZSM-5 nanocuboids were found to be 425.54 m²/g. This value and the obtained isotherms are consistent with the reported data for this class of materials. The specific surface of the parent ZSM-5 sample did not significantly change after the La³⁺ions exchange process (401.56 m²/g). On the other hand, the specific surface area of the hollow nanocrystals (345.68 m²/g) significantly reduced after encasing the platinum nanoparticles and formation of the ultra-conformal LaₓO_{y}H sol-gel coating layer to become 71.19 m²/g evidencing almost a complete blockage of the outer surface pores of the hollow ZMS-5 nanocrystals. This low porosity is not far from that of nonporous LaOH₃ rods. The fact that the La³⁺ ion exchanged sample possesses about 5 times larger surface area than the LaₓO_{y}H ultra-conformally coated sample explains why the encased platinum nanoparticles in the former samples are accessible while those in the second samples are not. This signifies the importance of the ultra-conformal sol-gel coating layer in suppressing the oxidative decomposition of the CVD carbon deposition precursor (ethylene) over the platinum nanoparticles to disclose the reason for the success of the CVD carbon deposition process when an ultra-conformally coated samples is utilized. It is noteworthy that the removal of the LaₓO_{y}H coating using 5.0 M HCl endows accessibility to the encased particles, which is essential for electrocatalysis applications. On the other hand, the BET surface area of the electron-conductive zeolitic nanoengineered samples obtained after the cavity formation process significantly improved (about 1.5-fold up), demonstrating the success of the proposed strategy in creating cavities and tunnels inside the electron-conductive hollow ZSM-5 nanocrystals to enable the platinum nanoparticles encasing. These assumptions are confirmed by the obtained microscopy images, FIG. 12.

### Nature of the Deposited Carbon

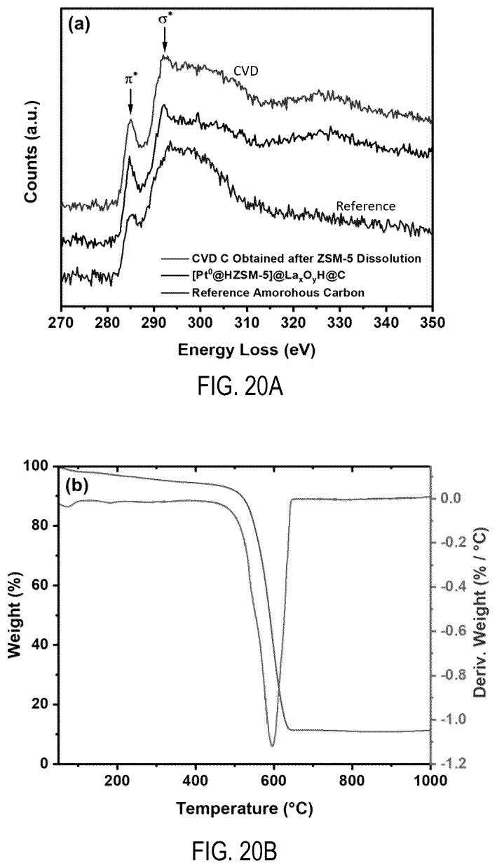

To shed the light on the nature of the CVD deposited carbon layer, the electron energy loss (EEL) spectra of the [Pt⁰@HZSM-5]@La(OH)₃@C, zeolite derived carbon (CVD C) obtained after the dissolution of the ZSM-5 nanocrystals, and a reference amorphous carbon sample (lacey carbon TEM grid) have been recorded. The two distinct sets of EELS profiles in FIG. 20 are revealing the non-amorphous nature of the CVD deposited carbon. The two sets displayed similar carbon (C) K edge shapes with different broadening. These edges align with previously published EELS data for carbon-based materials. The presence of two sharp peaks in the first set that includes [Pt⁰@HZSM-5]@LaₓO_{y}H@C and CVD C samples is an indicative of the graphitic-graphenic nature of the CVD deposited carbon. The peak at 285 eV can be assigned to the sp²π* molecular orbital transitions

$$( 1 s {\to }^{{e}^{-}} {π}^{*} ) ,$$

while the molecular orbital transitions to σ* orbitals

$$( 1 s {\to }^{{e}^{-}} {σ}^{*} ) , )$$

accounts for the more intense peak at 292 eV. On the other hand, the EELS profile of amorphous C is characterized by the presence of a broad peak at 290 eV and a less intense peak at 285 eV originating also from the σ* and π* transitions, respectively. A distinct peak of graphite is centered around 326 eV. The absence of this high eV peak in the EELS spectrum of amorphous carbon can be assigned to the lack of long range order and relaxation of the transition selection rules.

To further investigate the nature of the CVD deposited carbon layer, thermogravimetric analysis (TGA) was implemented as a simple and reliable analytical tool that can differentiate between the various carbon allotropes. The TGA curve of zeolite derived carbon (CVD C) displayed three weight loss processes. The first weight loss step (<103° C.) showed a weight loss of about 1.8% which can be ascribed to the removal of physically adsorbed water. At temperatures between 103° C. and 481° C. a gradual weight loss of 5.2% was observed, which can be assigned to the thermal elimination of the surface oxygen containing functional groups. A DTA peak that indicates the temperature of maximum mass decomposition rate (Tₘₐₓ) at 595° C. is identified in the final thermal decomposition step (480° C. to 640° C.) which exhibited a sharp weight loss of 81.5% corresponding to the decomposition of the zeolite derived carbon (CVD C) sample. These results and the fact that amorphous carbon has a Tₘₐₓ<<600° C. and graphite has a Tₘₐₓ>>600° C., further support the graphenic nature of the CVD deposited carbon.

### Electrochemical Measurements: CV, Capacitance, ORR Activity, and Durability

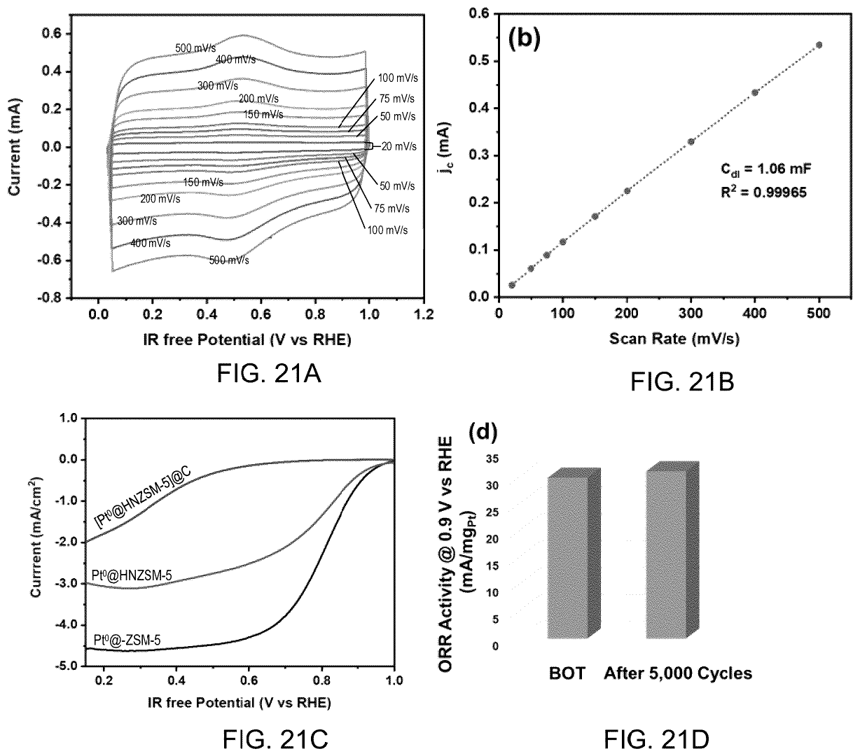

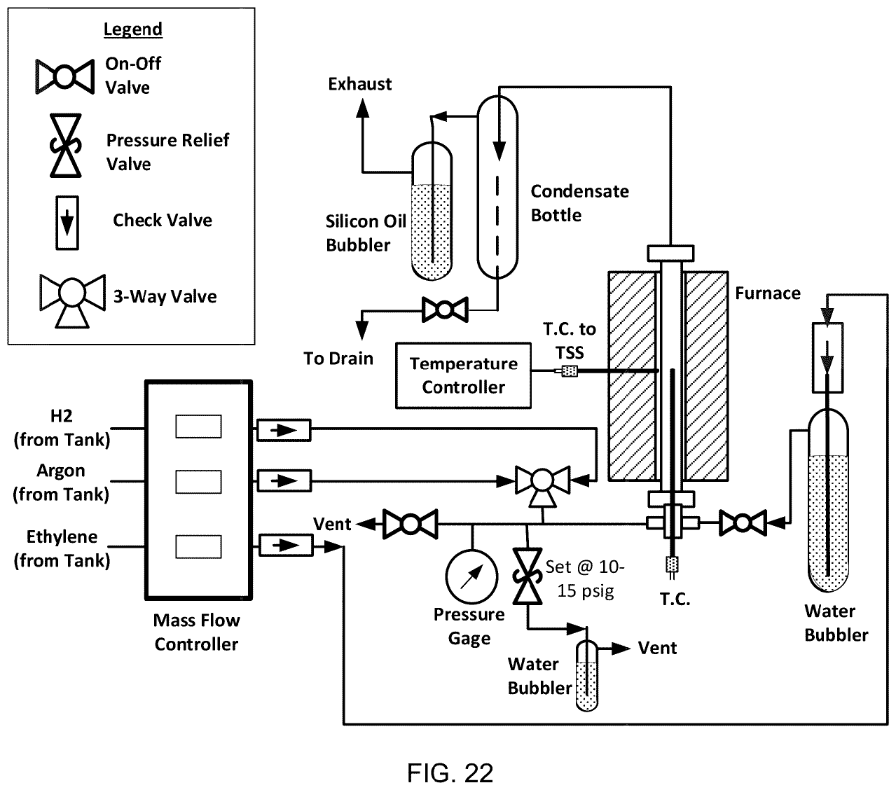

Cyclic voltammetry (CV) measurements were executed to evaluate the electron-conductivity, oxygen reduction reaction (ORR) activity, and durability of the prepared samples. First, the electrochemical performance of the electron-conductive ZSM-5 nanocrystals and its capacitance were examined by recording cyclic voltammograms (CVs) in argon-saturated 0.1 M HClO₄ supporting electrolyte at room temperature. FIG. 21A displays the acquired cyclic voltammograms from +0.05 to +1.0 Volts vs RHE at different scan rates of 20, 50, 75, 100, 150, 200, 300, 400, and 500 mV/s. The obtained CVs have a rectangular shape, lacking resistive slope, and are absent Faradaic redox peaks other than two broad peaks corresponding to the typical quinone-hydroquinone couple characteristic of carbon-based electrodes with oxygen surface functionalities. These results not only attest to the efficacy of the developed CVD carbon deposition process in imparting electron conductivity to the prepared samples and their potential to serve as electrode or electrocatalyst support material, particularly for fuel cell applications, but also their high purity. The presence of oxygen surface functional groups aligns with the TGA data analysis results.

$$= C = O + {e}^{-} + {H}^{+} ↔ C - OH$$

The double layer capacitance (Cdi) of the tested sample is calculated according to the following relation:

$${C}_{DL} = \frac{dQ}{dV} , {j}_{c} = \frac{dQ ( V )}{dt} \to {j}_{c} = {C}_{dl} \frac{dV}{dt} \to {j}_{c} = {C}_{dl} * v$$

where Q represents the charge (in coulombs), V represents the potential (in Volts), and je is the difference between the cathodic and anodic currents. A linear correlation is obtained from the plot of the non-Faradaic current (j_{c}) as a function of the scan rate, FIG. 21B. The capacitance of the tested electrode is calculated to be 14.50 F/g.

The application of the prepared samples as a cathode material for PEM fuel cells has been assessed using the oxygen reduction reaction (ORR) thin film rotating disk electrode (TF-RDE) technique. Three catalysts annealed at 900° C. were tested: non-encased platinum catalyst (Pt⁰-ZSM-5), encased platinum catalyst (Pt⁰@HZSM-5), electron-conductive encased platinum catalyst ([Pt⁰@HZSM-5]@C). The second catalyst is mixed with Ketjen carbon to improve its electron conductivity, while the last catalyst was treated with HF to improve its mass transport properties. FIG. 21C presents the positive going ORR polarization curves of the catalysts in O₂-saturated 0.1 M perchloric acid at room temperature with a TF-RDE rotation rate of 1600 rpm, and a sweep rate of 10 mVs⁻¹. The ORR half wave potentials (E_{1/2}) of the tested catalysts are 0.31, 0.78, and 0.8 V, respectively, indicating the superior ORR activity of the electron-conductive encased catalyst with its Ein being close to that of the commercial Pt/C catalyst. The encased platinum nanoparticles are sinter resistant while non-encased particles underwent sintering and lost electrochemically active surface area and ORR activity. The ORR mass activity of the electron-conductive encased catalyst at 0.9 V vs reversible hydrogen electrode (RHE) is more than double the mass activity of the encased catalyst mixed with carbon black (29.97 vs. 13.91 mA/mgpt) which reveals that the CVD deposited carbon is more effective than carbon black in providing electron transport to the encased platinum nanoparticles.

U.S. Department of Energy Accelerated Stress Test (AST) for Catalyst Supports. The AST was applied to investigate the long-term stability of the CVD deposited carbon by cycling the [Pt⁰@HZSM-5]@C catalyst within the potential window 1.0 to 1.5 V vs RHE at 500 mV/s in deaerated 0.1 M HClO₄. FIG. 21D illustrates that the ORR mass activity of the tested catalyst improved by ˜ 4% after 5,000 cycles, demonstrating the high durability of the CVD deposited carbon and its viability as fuel cell cathode catalyst host/support. However, the initial ORR mass activity is approximately 10× lower than that of commercial Pt/C catalyst. This might be attributed to the low platinum loading in the encased catalyst (4.06 wt %) with respect to 40-45 wt % in the commercial Pt/C catalyst. The low platinum loading required the utilization of thick electrode film during the RDE measurements and so the encased platinum nanoparticles may not be completely accessible due to the mass transport limitations within the thick film. To overcome this problem and make platinum nanoparticles more accessible, electron-conductive HZSM-5 catalysts with much higher platinum loading are required.

### Definitions

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The terms “coupled,” “connected,” and the like as used herein mean the joining of two members directly or indirectly to one another. Such joining may be stationary (e.g., permanent) or moveable (e.g., removable or releasable). Such joining may be achieved with the two members alone or the two members and any additional intermediate members being integrally formed as a single unitary body with one another or with the two members or the two members and any additional intermediate members being attached to one another.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A catalyst comprising:
a catalyst nanoparticle defining a catalyst surface; and
an electron-conductive hollow three-dimensional nano-zeolitic framework encasing the catalyst nanoparticle, the nano-zeolitic framework comprising:
an internal cavity in which the catalyst nanoparticle is disposed; and
a plurality of pores extending through the nano-zeolitic framework, allowing catalytic reactions at the catalyst surface, the plurality of pores having a predetermined pore size selected to selectively block undesired reactions at a the catalyst surface.

2. The catalyst of claim 1, wherein the nano-zeolitic framework is based on ZSM-5 cuboid nanocrystals.

3. The catalyst of claim 2, wherein the catalyst nanoparticle is platinum.

4. The catalyst of claim 1, wherein the catalyst nanoparticle is one of a group consisting of platinum, palladium, iridium, ruthenium, cobalt, nickel, and combinations thereof.

5. The catalyst of claim 1, wherein the nano-zeolitic framework is formed by coating an exterior surface of the nano-zeolitic framework with an ultraconformal carbon deposition aid layer and depositing carbon.

6. The catalyst of claim 1, wherein the nano-zeolitic framework is based on a zeolite having a pore size corresponding to the predetermined pore size.

7. The catalyst of claim 1, wherein:
the catalyst is an anode catalyst in a CO₂ electrolyzer;
the catalyst nanoparticle is platinum or iridium; and
the predetermined pore size blocks diffusion of a CO₂ reduction reaction product through the plurality of pores.

8. The catalyst of claim 7, wherein the CO₂ reduction reaction product is formate, carbon monoxide, or methane.

9. The catalyst of claim 1, wherein:
the catalyst is a cathode catalyst in a direct methanol fuel cell;
the catalyst nanoparticle is platinum or a platinum alloy; and
the predetermined pore size blocks diffusion of methanol from an anode of the direct methanol fuel cell through the plurality of pores.

10. The catalyst of claim 1, wherein:
the catalyst is a cathode catalyst in a proton exchange membrane fuel cell;
the catalyst nanoparticle is platinum or a platinum alloy; and
the predetermined pore size blocks cathode-ionomer interactions through the plurality of pores.

11. A method of improving Faradaic efficiency in an electrochemical device, comprising:
providing a catalyst at an electrode of the electrochemical device, the catalyst comprising:
a nanoparticle comprising a metal or a metal alloy, the nanoparticle selected to improve catalytic performance in the electrochemical device; and
an electron-conductive nano-zeolitic framework encasing the nanoparticle, the nano-zeolitic framework comprising:
a hollow three-dimensional framework defining a catalyst surface;
an internal cavity in which the nanoparticle is disposed; and
a plurality of pores extending through the nano-zeolitic framework, the plurality of pores having a size and shape selected to block molecules
corresponding to undesired reactions in the electrochemical device;
selectively promoting a desired reaction at the catalyst surface; and
selectively blocking the undesired reactions at the catalyst surface.

12. A method of synthesizing encased platinum nanoparticles in an electron-conductive hollow three-dimensional nano-zeolitic framework, comprising:
forming a nano-zeolitic framework with a first reaction mixture comprising ZSM-5 cuboid nanocrystals and a platinum precursor and evaporating a solvent of the first reaction mixture under nitrogen flow to form Pt²⁺-ZSM-5;
forming a hollow nano-zeolitic framework with a second reaction mixture comprising Pt²⁺-ZSM-5 and a structure directing agent and hydrothermally treating the second reaction mixture to form Pt²⁺@HZSM-5;
encasing platinum nanoparticles in the hollow nano-zeolitic framework by injecting the Pt²⁺@HZSM-5 with an NaBH₄ solution, forming Pt⁰@HZSM-5;
coating the encased platinum nanoparticles in the hollow nano-zeolitic framework with LaₓO_{y}H, a conformal carbon deposition aid layer, by forming a third reaction mixture comprising Pt⁰@HZSM-5 and La(NO₃)₃·6H₂O and hydrothermally treating the third reaction mixture to form [Pt⁰@HZSM-5]169 LaₓO_{y}H;
applying a chemical vapor deposition process to deposit carbon on the [Pt⁰@HZSM-5]169 LaₓO_{y}H and form electron-conductive [Pt⁰@HZSM-5]169 LaₓO_{y}H@C; and
forming encased platinum nanoparticles in the electron-conductive hollow three-dimensional nano-zeolitic framework by acid etching the [Pt⁰@HZSM-5]169 LaₓO_{y}H@C to remove the conformal carbon deposition aid layer, forming [Pt⁰@HZSM-5]169 C.

13. The method of claim 12, wherein in LaₓO_{y}H, values of x range from 1-3, and values of y range from 3-6.

14. The method of claim 12, wherein the structure directing agent is tetrapropylammonium hydroxide.

15. The method of claim 12, wherein the chemical vapor deposition process includes carbonization and graphitization.

16. The method of claim 12, wherein acid etching is performed with hydrochloric acid (HCl).

17. A method of synthesizing encased platinum nanoparticles in an electron-conductive hollow three-dimensional nano-zeolitic framework, comprising:
forming hollow nano-zeolitic framework by forming a first reaction mixture comprising ZSM-5 and a structure directing agent and hydrothermally treating the first reaction mixture to form HZSM-5;
performing an ion exchange treatment on the HZSM-5 with La(NO₃)₃·6H₂O to form La³⁺-HZSM-5;
forming an electron-conductive hollow nano-zeolitic framework using a chemical vapor deposition process to deposit carbon on the La³⁺-HZSM-5 to form [LaₓO_{y}H-HZSM-5]@C;
forming cavities within the electron-conductive hollow nano-zeolitic framework by acid treating the [LaₓO_{y}H-HZSM-5]@C to dissolve a LaₓO_{y} layer and form HZSM-5@C; and
encasing platinum nanoparticles in the electron-conductive hollow nano-zeolitic framework by forming a second reaction mixture comprising [Pt(NH₃)₄](NO₃)₂ and the HZSM-5@C, hydrothermally treating the second reaction mixture with the structure directing agent and reducing the second reaction mixture with an NaBH₄ solution to form [Pt⁰@HZSM-5]@C.

18. The method of claim 17, wherein the structure directing agent is tetrapropylammonium hydroxide.

19. The method of claim 17, wherein the chemical vapor deposition process includes carbonization and graphitization.

20. The method of claim 17, wherein acid treating the [LaₓO_{y}H-HZSM-5]@C comprises treating the [LaₓO_{y}H-HZSM-5]@C twice with HCl.
